(19) United States
(12) Patent Application Publication
(10) Pub. No.: US 2025/0344242 A1
(43) Pub. Date: Nov. 6, 2025

(54) NON-PRIMARY CHANNEL ACCESS IN WIRELESS NETWORKS

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Rubayet Shafin, Allen, TX (US); Peshal Nayak, Plano, TX (US); Yue Qi, Plano, TX (US); Bilal Sadiq, Frisco, TX (US)

(21) Appl. No.: 19/190,538

(22) Filed: Apr. 25, 2025

Related U.S. Application Data
(60) Provisional application No. 63/643,095, filed on May 6, 2024.
(60) Provisional application No. 63/678,235, filed on Aug. 1, 2024.
(60) Provisional application No. 63/681,518, filed on Aug. 9, 2024.
(60) Provisional application No. 63/692,392, filed on Sep. 9, 2024.
(60) Provisional application No. 63/716,058, filed on Nov. 4, 2024.
(60) Provisional application No. 63/717,576, filed on Nov. 7, 2024.
(60) Provisional application No. 63/752,264, filed on Jan. 31, 2025.
(60) Provisional application No. 63/763,689, filed on Feb. 26, 2025.

(51) Int. Cl. H04W 74/00; H04W 74/08

(52) U.S. Cl. CPC H04W 74/002; H04W 74/08

(57) ABSTRACT

An access point (AP) may enable and manage non-primary channel access (NPCA) with a station (STA). The AP and the STA may each specify various switching rules for triggering channel switch from a primary channel to a backup NPCA primary channel for NPCA operation, including rules regarding switching delays by which a switch may need to perform and rules regarding whether a primary channel is occupied by an overlapping basic service set (BSS). The AP and the STA may also exchange various frames that provide a capability indication regarding support for NPCA operation as well as one or more parameters and rules regarding the NPCA operation.

### CROSS-REFERENCE TO RELATED APPLICATIONS

This application claims the benefit of priority from U.S. Provisional Application No. 63/643,095 entitled “PERFORMING CHANNEL SWITCH FOR NON-PRIMARY CHANNEL ACCESS IN WIFI” filed May 6, 2024; U.S. Provisional Application No. 63/678,235, entitled “PERFORMING CHANNEL SWITCH FOR NON-PRIMARY CHANNEL ACCESS IN WIFI” filed Aug. 1, 2024; U.S. Provisional Application No. 63/681,518, entitled “PERFORMING CHANNEL SWITCH FOR NON-PRIMARY CHANNEL ACCESS IN WIFI” filed Aug. 9, 2024; U.S. Provisional Application No. 63/692,392, entitled “PERFORMING CHANNEL SWITCH FOR NON-PRIMARY CHANNEL ACCESS IN WIFI” filed Sep. 9, 2024; U.S. Provisional Application No. 63/716,058, entitled “PERFORMING CHANNEL SWITCH FOR NON-PRIMARY CHANNEL ACCESS IN WIFI” filed Nov. 4, 2024; U.S. Provisional Application No. 63/717,576, entitled “PERFORMING CHANNEL SWITCH FOR NON-PRIMARY CHANNEL ACCESS IN WIFI” filed Nov. 7, 2024; U.S. Provisional Application No. 63/752,264, entitled “PERFORMING CHANNEL SWITCH FOR NON-PRIMARY CHANNEL ACCESS IN WIFI” filed Jan. 31, 2025; and U.S. Provisional Application No. 63/763,689, entitled “PERFORMING CHANNEL SWITCH FOR NON-PRIMARY CHANNEL ACCESS IN WIFI” filed Feb. 26, 2025 which are all incorporated herein by reference in their entireties.

### TECHNICAL FIELD

This disclosure relates generally to a wireless communication system, and more particularly to, for example, but not limited to, non-primary channel access (NPCA) operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an APMLD. Each of multiple links may enable channel access and frame exchanges between the non-APMLD and the APMLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network, the AP comprising: a memory; and a processor coupled to the memory. The processor configured is to operate on a primary channel within a basic service set (BSS) bandwidth. The processor is configured to transmit, to a station (STA), a first frame including a first field indicating whether NPCA operation is enabled. The processor is configured to, in a case that the first field indicates the NPCA operation is enabled, switch from the primary channel to an NPCA primary channel within the BSS bandwidth based on a determination that i) a physical-layer protocol data unit (PPDU) observed on the primary channel is classified as an inter-BSS PPDU, and ii) an operating channel occupied by the PPDU does not overlap with the NPCA primary channel. The processor is configured to transmit, to the STA, a second frame on the NPCA primary channel.

In some embodiments, the processor is configured to transmit, to the STA, a third frame indicating whether the AP supports NPCA operation.

In some embodiments, the processor is configured to switch from the primary channel to the NPCA primary channel based on a determination that a duration of the PPDU is greater than a predetermined value.

In some embodiments, the processor is configured to switch from the primary channel to the NPCA primary channel based on a duration of a transmission opportunity (TXOP) associated with the PPDU is greater than a predetermined value.

In some embodiments, the first frame includes: a second field indicating a time needed to switch from the primary channel to the NPCA primary channel; and a third field indicating a time needed to switch back from the NPCA primary channel to the primary channel.

In some embodiments, the first frame includes a second field that indicates a channel number of a channel within the BSS bandwidth that corresponds to the NPCA primary channel.

In some embodiments, the first frame includes a second field that indicates a minimum duration of the PPDU or the TXOP on the primary channel to switch to the NPCA primary channel.

In some embodiments, the processor is configured to determine that the duration of the PPDU is greater than a value indicated in the minimum duration of the second field.

In some embodiments, the processor is configured to determine that the duration of the TXOP is greater than a value indicated in the minimum duration of the second field.

In some embodiments, the processor is configured to in a case that the first field indicates that the NPCA operation is not enabled, abstain from switching from the primary channel to the NPCA primary channel.

One aspect of the present disclosure provides a station (STA) in a wireless network, the STA comprising: a memory; and a processor coupled to the memory. The processor is configured to operate on a primary channel within a basic service set (BSS) bandwidth. The processor is configured to receive, from an access point (AP), a first frame including a first field indicating whether NPCA operation is enabled. The processor is configured to, in a case that the first field indicates the NPCA operation is enabled, the STA may enable NPCA operation and switch from the primary channel to an NPCA primary channel within the BSS bandwidth based on a determination that i) a physical-layer protocol data unit (PPDU) observed on the primary channel is classified as an inter-BSS PPDU and ii) an operating channel occupied by the PPDU does not overlap with the NPCA primary channel. The processor is configured to receive, from the AP, a second frame on the NPCA primary channel.

In some embodiments, the processor is configured to transmit a third frame to the AP indicating whether the STA supports NPCA operation.

In some embodiments, the processor is configured to receive, from the AP, a third frame indicating whether the AP supports NPCA operation.

In some embodiments, the processor is configured to switch from the primary channel to the NPCA primary channel based on a determination that a duration of the PPDU is greater than a predetermined value.

In some embodiments, the processor is configured to switch from the primary channel to the NPCA primary channel based on a duration of a transmission opportunity (TXOP) associated with the PPDU is greater than a predetermined value.

In some embodiments, the first frame includes: a second field indicating a time needed to switch from the primary channel to the NPCA primary channel; and a third field indicating a time needed to switch back from the NPCA primary channel to the primary channel.

In some embodiments, the first frame includes a second field that indicates a channel number of a channel within the BSS bandwidth that corresponds to the NPCA primary channel.

In some embodiments, the first frame includes a second field that indicates a minimum duration of the PPDU or the TXOP on the primary channel to switch to the NPCA primary channel.

In some embodiments, the processor is configured to determine that the duration of the PPDU is greater than a value indicated in the minimum duration of the second field.

In some embodiments, the processor is configured to determine that the duration of the TXOP is greater than a value indicated in the minimum duration of the second

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a channel access procedure on a secondary channel via channel bonding in accordance with an embodiment.

FIG. 5 illustrates an example system architecture with multiple basic service sets (BSSs) in accordance with an embodiment.

FIG. 6 illustrates a ultra-high reliability (UHR) capabilities element that includes a non- primary channel access (NPCA) capability indication in accordance with an embodiment.

FIG. 7 illustrates an NPCA notification frame and a NPCA control element in accordance with an embodiment.

FIG. 8 illustrates a UHR Operation element with NPCA parameters in accordance with an embodiment.

FIG. 9 illustrates an NPCA support notification frame in accordance with an embodiment.

FIG. 10 illustrates a flow chart of rules to be applied to a physical layer protocol data unit (PPDU) observed on the primary channel (PCH) in accordance with an embodiment.

FIG. 11 a flow chart of an example process of the rules to be applied to a PPDU observed on a primary channel in accordance with an embodiment.

FIG. 12 illustrates an NPCA Trigger Conditions field of an NPCA Control element in accordance with an embodiment.

FIG. 13 illustrates a broadcast target wake time (TWT) element with fields to indicate that the TWT is for unavailability indication in accordance with an embodiment.

FIG. 14 illustrates an NPCA unavailability indication using a multi-STA Block Ack frame in accordance with an embodiment.

FIG. 15 illustrates NPCA Trigger Conditions indication by a non-AP STA within the NPCA Support Notification frame in accordance with an embodiment.

FIG. 16 illustrates an NPCA Coordination Request frame in accordance with an embodiment.

FIG. 17 illustrates a flow chart of an example process performed by an AP for initiating NPCA operation in accordance with an embodiment.

FIG. 18 illustrates a flow chart of an example process performed by a non-AP STA for supporting NPCA operation and performing channel switch in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed U plink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, A P, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

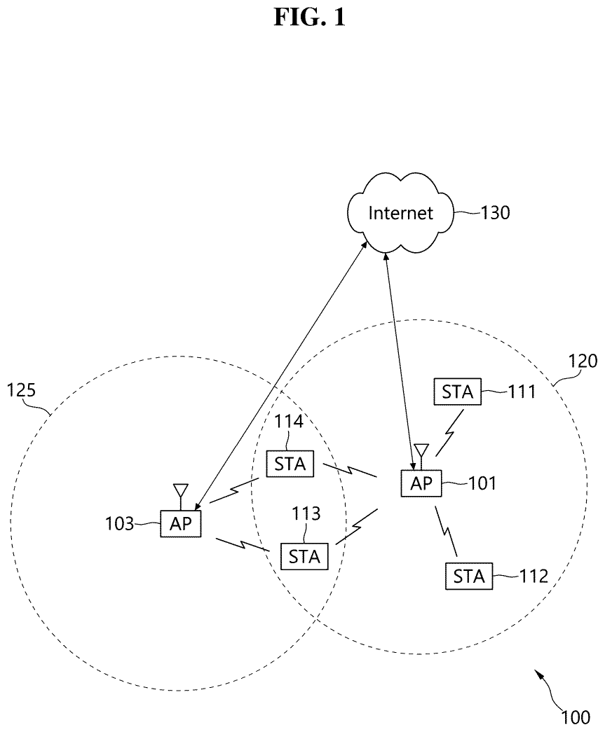

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the A Ps may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of A Ps and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

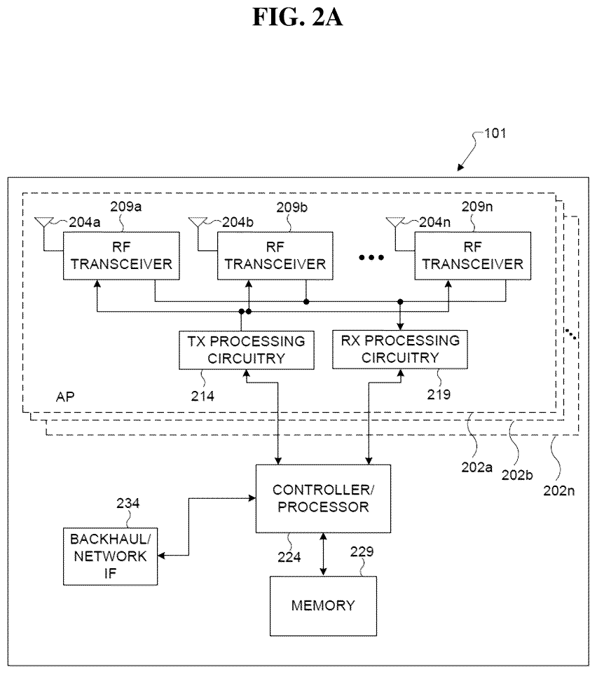

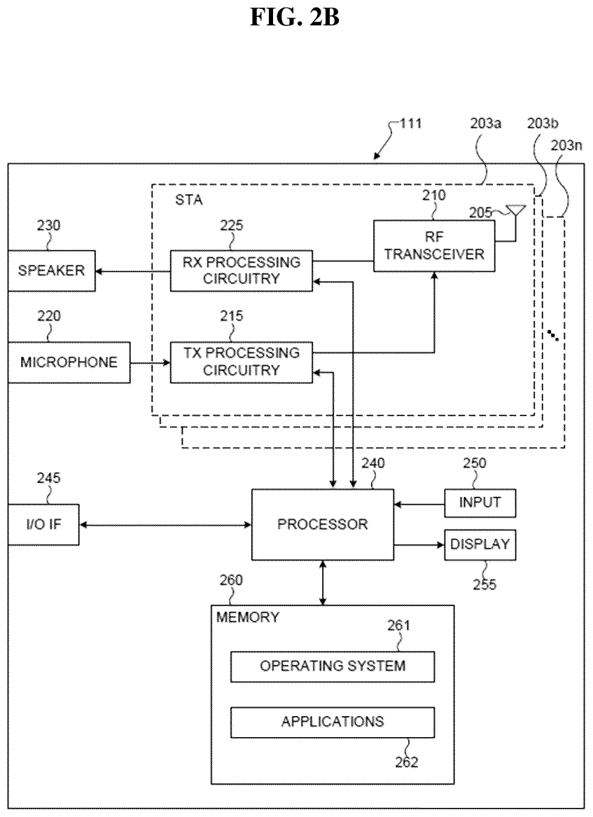

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STA s in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STA s 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of A P 101, various changes may be made to FIG. 2A. For example, the A P 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STA s could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

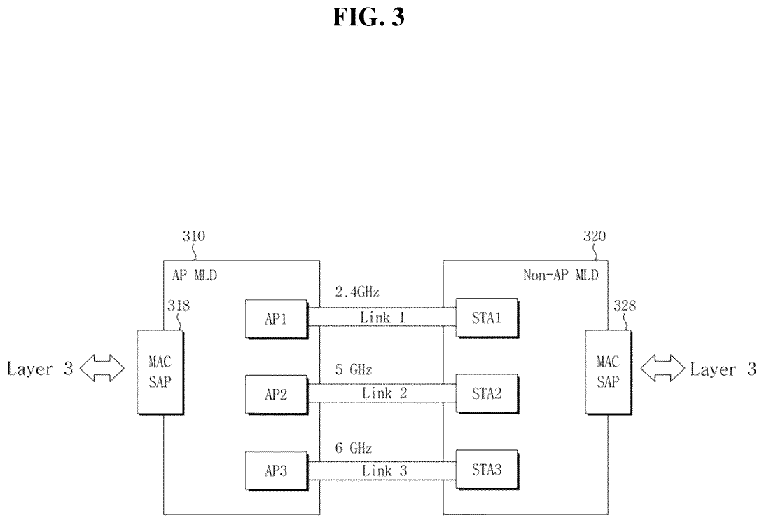

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated A Ps of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

Before the IEEE 802.11n WiFi standard (up to 802.11g), WiFi devices were allowed to use up to 20 MHz of operating bandwidth. Since IEEE 802.11n, the concept of channel bonding was introduced to improve throughput, where a wireless device can opportunistically bond a non- primary channel along with a primary 20 MHz channel to transmit packets with a higher bandwidth. IEEE 802.11n considered bonding up to 40 MHz. IEEE 802.11ac expanded channel bonding up to 80 and 160 MHz. IEEE 802.11ax expanded channel bonding up to 160 MHz and introduced idea of puncturing. IEEE 802.11be introduced channel bonding up to 320 MHz and further developed the puncturing concept to more configurations. The benefits of channel bonding are two-fold. First, if a neighbor basic service set (BSS) is idle, there is a clear benefit of increased throughput. Second, if a neighbor BSS has traffic, channel bonding can cause a neighbor BSS to be unable to access the channel by taking away its primary channel. Accordingly, channel bonding may improve transmission efficiency (and hence throughput), at the cost of increased latency.

Before performing transmission on a 20 MHz or wider channel, a wireless device may need to perform the clear channel assessment (CCA) procedure to determine if a channel is BUSY or IDLE. There are two mechanisms to perform CCA which are CCA preamble detection (CCA PD) and CCA energy detection (CCA ED). The CCA PD detects a channel as being BUSY when it observes a preamble on that channel that can be used to set the Network Allocation Vector (NAV) time. The CCA ED detects a channel BUSY condition when a received signal strength exceeds the CCA-ED threshold as given by dot110FDMEDThreshold for the primary 20 MHz channel, dot11OFDMEDThreshold for the secondary 20 MHz channel (if present), dot110FDMEDThreshold+3 dB for the secondary 40 MHz channel (if present), and dot110FDMEDThreshold+6 dB for the secondary 80 MHz channel (if present). Otherwise, the channel is detected as IDLE.

When a STA supports multiple channel widths, an enhanced distributed channel access (EDCA) transmission opportunity (TXOP) may be obtained based solely on the activity of the primary channel. This TXOP may be won by the conventional random backoff procedure. Once an EDCA TXOP has been obtained using the IDLE state of the primary channel, a wider bandwidth transmission may be used during the TXOP based on the state of CCA on a secondary channel, secondary 40 MHz channel, or secondary 80 MHz channel, among others. A wider bandwidth transmission is allowed if the secondary channel is idle during an interval of Point Coordination Function Interframe Space (PIFS) preceding start of the TXOP on the primary channel.

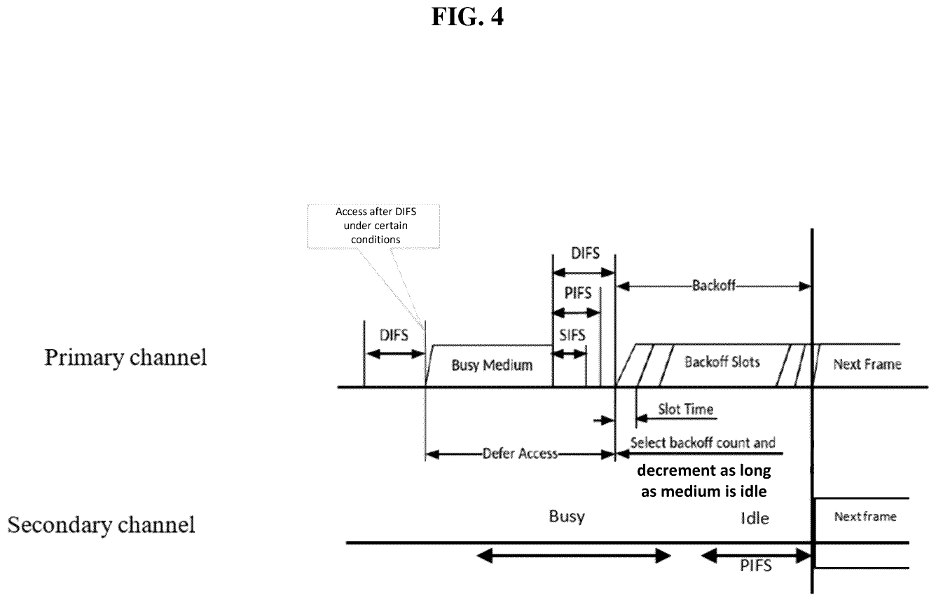

FIG. 4 illustrates a channel access procedure on a secondary channel via channel bonding in accordance with an embodiment. Since the bandwidth of a transmitted frame can be opportunistically increased by channel bonding, to enable reception of the transmitted frame, the preamble is usually duplicated on all the 20 MHz bands used for transmission. It should be noted that the primary 20 MHz channel must always be used for transmission. In fact, the management and control frames are always transmitted on the primary 20 MHz channel and may be duplicated on other secondary channels (in a duplicate PPDU format).

The AP or an associated non-AP STA can transmit on any non-primary channel if it also transmits on the primary channel. If the primary channel is busy due to Overlapping Basic Service Set (OBSS) TXOP, then no transmission is possible even if there is a secondary channel that is idle. This can increase the channel access delay and reduce the efficiency of channel utilization. As a solution to this, the mechanism of non-primary channel access (NPCA) has been proposed. When an AP enables NPCA operation, the AP may also disclose one or more back-up 20 MHz primary channels, which may be referred to herein as one or more NPCA primary channels. If an OBSS transmission occupies the primary channel of the AP for a certain duration, the A P and associated non-AP STAs that support NPCA may switch to one of the back-up primary channels, which may be referred to herein as an NPCA primary channel, for performing frame exchanges, while treating that backup channel as the temporary primary channel till the end of the duration on the main primary channel. These exchanges may continue till either: i) the end of the Physical Layer Protocol Data Unit (PPDU) duration set by the OBSS transmission on the primary channel or ii) the end of the NAV duration set by the OBSS transmission on primary channel. These two variants may be referred to as PPDU duration based NPCA and NAV duration based NPCA, respectively. The AP and non-AP STAs may return to the primary channel by the end of this duration. There are several issues to be addressed for such NPCA operations. In particular, the bandwidth (BW) occupied by the OBSS transmission that occupies the primary channel may need to be identified by the AP and/or STAs supporting NPCA operation. This includes APs and STAs that have reduced reception capabilities initially. Furthermore, the NAV set by the OBSS transmission that occupies the primary channel may need to be identified by the AP and/or STAs supporting NPCA operation. This includes APs and STAs that have reduced reception capabilities initially.

Due to hidden node issues among others, some STAs may transition to a backup primary channel when the AP does not or vice versa, which may cause wastage of power. The switch to a backup primary channel can cause disruption to neighboring APs that operate on that channel.

Based on the standards, the bandwidth indication for a PPDU is performed as follows. In a non-high throughput (non-HT) PPDU, the bandwidth (BW) is not indicated since the PPDU BW is 20 MHz by default. In a non-HT duplicate PPDU format, to indicate the BW some of the initialization scramble bits at the transmitter are used. While scramble bits are randomly initialized in HT clause, a change was made in Very High Throughput (VHT), where 2 bits of bandwidth information and 1 bit of static/dynamic indication was provided in the scrambler initialization. When scramble bits include the BW signaling information, the Individual/Group bit of the transmit address (TA) of the frame is set to 1. This is called a bandwidth signaling TA. In a HT PPDU, the BW is indicated in the CBW 20/40 subfield of HT-SIG1 field. In a VHT PPDU, the VHT-SIG-A1 field indicates the BW: {20,40,80,160/80+80}. In a High Efficiency (HE) PPDU, the HE-SIG-A1 field indicates the BW: {20,40,80,160/80+80, Punctured}. In an Extremely High Throughput (EHT) PPDU, the BW subfield of the U-SIG1 field indicates the BW: {20,40,80,160,320}. In Multi-User (MU) PPDU mode, PuncValue and PuncPatter fields of U-SIG field indicate the punctured 20 MHz channels.

The fields discussed above may be repeated on each 20 MHz band of PPDU and thus can be decoded on any 20 MHz sub-band of the PPDU BW. It should be noted that the bandwidth signaling Transmitter Address (TA) may not be used in some control frames transmitted in non-HT duplicate PPDU format, such as a Clear-to-send (CTS) frame, a Multi-User Request-To-Send (MU-RTS) frame, among others, and thus they can't be used to identify the bandwidth of the PPDU.

In a baseline spec, the NAV duration is indicated by a PPDU as described herein. Before 802.11ax (HE), the NAV duration can be set from the Duration field of the Media Access Control (MAC) header. Since the MAC header is “not” duplicated over all the 20 MHz bands, this implies that a STA can't set NAV from a pre-HE TXOP from another BSS unless the STA's operating BW is >=the PPDU BW. One exception is if the transmissions are in non-HT duplicate PPDU format (used for CTS/RTS, among others)

In HE/EHT PPDU, the NAV duration is “additionally” indicated in the TXOP subfield of the HE-SIG-A2/U-SIG1 field. But the granularity of encoding is 8 μs (for TXOP<512 μs) or 128 μs for longer TXOPs. The TXOP field is set using a floor function, e.g., it underestimates actual duration by up to 128 μs.

Several modes have also been defined where an AP or a non-AP STA initially support a reduced capability of transmission or reception. These include the following as described herein. Enhanced Multi-link Single Radio (EM LSR) in accordance with this disclosure is described herein. In order to save power and minimize the degradation in performance, this EM LSR mode of operation for a non-AP multi-link device (MLD) was defined. In EM LSR mode, by default the STAs of the non-AP MLD operate with reduced capabilities, called listen operation. Operating in listen state enables the non-AP STA to save power. However, upon receiving a request within a TXOP, the non-AP STA can increase one or more of its supported bandwidth (BW), supported PPDU formats, and number of spatial stream (NSS) set for at least the duration of the TXOP. Thus, after sending a request to the non-AP STA to increase the capabilities, the TXOP owner can perform communication at the enhanced channel width, PPDU formats, and NSS values for the rest of the TXOP. During this TXOP, the other STA s affiliated with the non-AP MLD are inactive. More recently, proposals to extend EM LSR to single link devices or for independent operation on each of the links have also been made, called single-link EM LSR operation.

Dynamic Sub-band Operation (DSO) in accordance with this disclosure is described herein. To improve the channel utilization when an AP has a wider bandwidth than associated non-AP STAs, a mode of operation called DSO has been proposed for non-AP STAs. In DSO, upon winning channel access and in the beginning of a TXOP, the AP can provide an indication to the DSO STAs the Subchannels on which it intends to serve them within the TXOP or Service Period (SP). Here the subchannel can be, for example, either a 20 MHz channel or a resource unit (RU), that is a part of the frequency on which the channel access has been won and which can even be outside of the primary channel the STA monitors. These subchannels may also be referred to herein as sub-bands in some embodiments. Upon receiving the indication, the indicated STA s may switch to the indicated subchannel for the remaining duration of the TXOP or SP to receive frames from the AP. This mechanism can help efficiently utilize the full BSS bandwidth of the AP, when the associated STAs support a smaller bandwidth.

Dynamic Power Save (DPS) in accordance with this disclosure is described herein. In order to save power, and minimize the degradation in performance for latency sensitive traffic, a mode of operation for an AP called DPS mode has been proposed. In DPS mode, by default the AP may operate with reduced capabilities. Operating with reduced capabilities may enable the A P to save power. However, upon receiving a request within a TXOP, the AP can increase one or more of its supported bandwidth (BW), supported PPDU formats, Modulation and Coding Scheme (M CS) set and Number of Spatial Streams (NSS) set for at least the duration of the TXOP. Thus, after sending a request to the AP to increase the capabilities of an AP, the TXOP owner can perform communication at the enhanced channel width, PPDU formats, M CS and NSS values for the rest of the TXOP.

IEEE 802.11be supports multiple bands of operation, where an access point (AP) and a non-AP device can communicate with each other, called links. Thus, both the AP and non-AP device may be capable of communicating on different bands or links, which may be referred to herein as multi-link operation (MLO). Devices capable of MLO operation may be referred to herein as multi-link devices (MLDs).

Several embodiments as described herein may include a basic service set (BSS) with an AP and one or more associated STA s. In addition, there may be several overlapping BSSs which also contend for the wireless medium. In order to enhance the spectrum utilization and minimize channel access latency the AP may enable non-primary channel access (NPCA) operation.

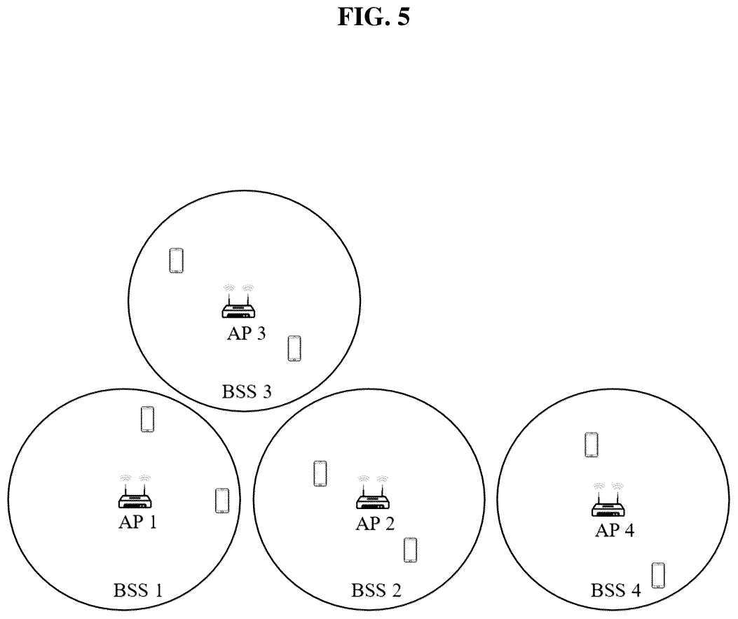

FIG. 5 illustrates an example system architecture with multiple BSSs. In particular, FIG. 5 illustrates a system layout where BSS1 operated by AP1 is the BSS of interest which intends to perform NPCA, while BSS 2-4 are BSSs where the signals may overlap (signal overlap not illustrated in FIG. 5), which may be referred to as overlapping BSSs (OBSSs) which may operate on an overlapping bandwidth.

Capability indication in accordance with this disclosure is described herein. In some embodiments, it may be mandatory for an Ultra High Reliability (UHR) AP STA and/or a UHR non-AP STA to support non-primary channel access (NPCA) operation. In some embodiment, a UHR AP STA may indicate if it supports NPCA operation by setting a capability bit to 1 in the UHR Capabilities element that it transmits in Beacon and Probe Response frames. Otherwise, the bit may be set to 0. The bit can be called, for example, the NPCA Support subfield. In some embodiments, a UHR non-AP STA may indicate if it supports NPCA operation by setting a capability bit to 1 in the UHR Capabilities element that it transmits in probe request and association request frames. Otherwise, the bit may be set to 0. The bit can be called, for example, NPCA Support subfield.

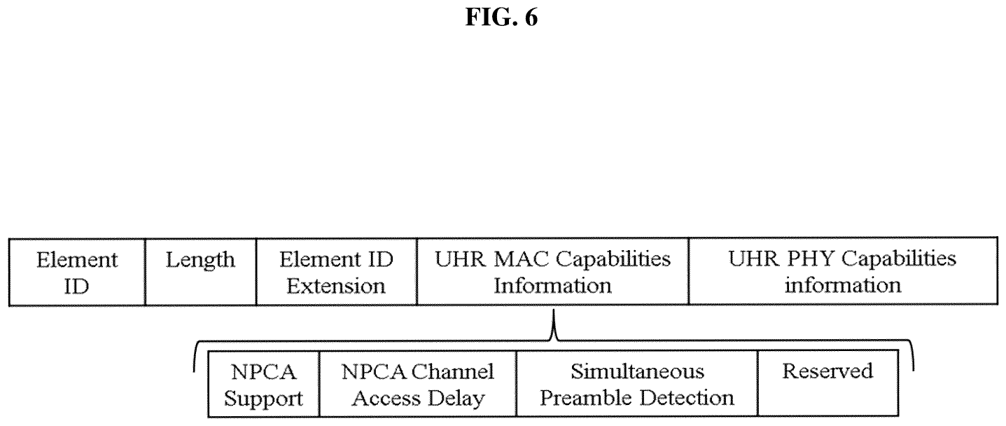

FIG. 6 illustrates a UHR capabilities element that includes a NPCA capability indication in accordance with an embodiment. The element includes an element ID field, a length field, an element ID extension field, a UHR MAC capabilities information field, a UHR physical layer (PHY) capabilities information field. The UHR MAC capabilities field may include an NPCA support field, a NPCA channel access delay field, a simultaneous preamble detection field, and a reserved field. The element ID field may provide an identifier for the element. The length field may provide length information for the element. The element ID extension field may provide ID extension information. The UHR MAC capabilities field may provide information regarding support for NPCA operation. The UHR PHY capabilities information may provide PHY capabilities information. The NPCA support field may provide an indication regarding whether the AP or non-AP STA supports NPCA operation. In some embodiment, a UHR AP or non-AP STA may indicate if it supports NPCA operation by setting a capability bit to 1 in the NPCA support field. Otherwise, the bit may be set to 0. In some embodiments, an AP or non-AP STA may also indicate in its UHR Capabilities the time it requires to switch to and be capable of reception on the back-up primary channel when operating in NPCA mode. This can be indicated in the NPCA Channel Access Delay field.

In some embodiments, a STA may also indicate in its UHR Capabilities the time it requires to switch to and be capable of reception on the primary channel after the end of transmission on the backup channel. This can be indicated in a separate NPCA Transition Delay field or the value can be same as NPCA Channel Access Delay field (i.e., no separate field required for indication). In some embodiments, some of the aforementioned fields may be applicable for indication by an AP or for indication by a non-AP STA. In some embodiments, one or more of the indications can be carried in a separate element carried by the AP, such as the UHR Operation element, or as fields in a frame transmitted by the AP, such as the Probe Response frame, a new Action frame, Beacon frame among others. In some embodiments, one or more of the indications can be carried by the AP in the frame that it transmits to enable NPCA operation as described herein. These fields may also be referred to herein as, for example, NPCA Channel Switch Delay and NPCA Switch Back Delay, respectively.

In some embodiments, an AP or non-AP STA may also indicate in its UHR Capabilities the ability to perform simultaneous preamble detection on the primary channel and the backup primary channel when NPCA is enabled. This can be indicated in the Simultaneous Preamble Detection field as shown in FIG. 6 in accordance with an embodiment. The reserved field may be reserved.

In some embodiments, the AP may also indicate the maximum NPCA Channel Access Delay, and/or maximum NPCA Transition Delay that it is willing to accommodate from any associated STA participating in NPCA operation. Correspondingly an associated non-AP STA may enable NPCA operation and participate in NPCA behavior only if the AP has enabled NPCA operation, and the non-AP STAS NPCA Channel Access Delay, and/or NPCA Transition Delay are lower than the maximum supported values indicated by the AP. In some embodiments, the maximum NPCA Channel Access Delay, and/or maximum NPCA Transition Delay can be indicated by the AP in its Ultra-High Reliability (UHR) Capabilities element in the Maximum NPCA Channel Access Delay, and Maximum NPCA Transition Delay fields, respectively. In some embodiments, these fields may be referred to as a Maximum NPCA Channel Switch Delay and a Maximum NPCA Channel Switch Back Delay, respectively. In some embodiments, these values can be indicated in another element, such as the UHR Operation element, or frame transmitted by the AP. In some embodiments, these values can be indicated by the AP during the NPCA enablement procedure as described herein. In some embodiments, after determining that an observed transmission on the primary channel is eligible for performing NPCA switch, the AP shall initiate the channel access and/or the transmissions on the NPCA backup primary channel the Maximum NPCA Channel Access Delay after that determination time.

In some embodiments, the capability to support NPCA and the other NPCA parameters may differ for each STA of an MLD, and so the capability indication can be distinct for each STA. In some embodiments, the capability and parameters can either be indicated by using a NPCA Support Bitmap, or by including the NPCA Support and NPCA Channel Access Delay fields in the Per STA Profile of the Basic Multi-link element transmitted by the MLD.

Enabling, disabling, and updating of NPCA operation by an AP in accordance with this disclosure is described herein. In some embodiments, an AP that indicates support for NPCA implicitly has NPCA operation enabled. In some embodiments, NPCA operation may be a mode that can be enabled or disabled by the AP for its BSS by performing broadcast signaling. In some embodiments, this NPCA operation mode switch may be performed independently for each link. In some embodiments, the mode switch may be performed jointly for one or more links. An AP can perform the broadcast signaling by using an action frame, which may be referred to herein as a NPCA Notification frame, or by including a new element or field in the beacon (or other broadcast frames) called NPCA Control element or field to indicate enablement, disablement or an update in NPCA operation. This NPCA Control element or field may also be carried in Probe Response and Association Response frames transmitted by the A P. This broadcast signaling may include an indication of one or more of the following. The purpose of signaling: Enable, Disable or Update of NPCA operation. An indication of the time when the indicated signaling will take effect. The current status of NPCA operation (e.g., active, inactive, among others). An indication of the backup primary 20 MHz channel for NPCA operation. An indication of one or more NPCA parameters. A list of rules for NPCA channel switch along with applicable parameters as described herein. An indication of the type of NPCA switches allowed (e.g., NAV duration based NPCA or PPDU duration based NPCA, among others). A list of rules for channel access on the backup channel during NPCA operation. In some embodiments, one or more of the above indications may also be carried as a subfield of another element such as the UHR Operation element, where the field may be referred to as a NPCA Operation Information field.

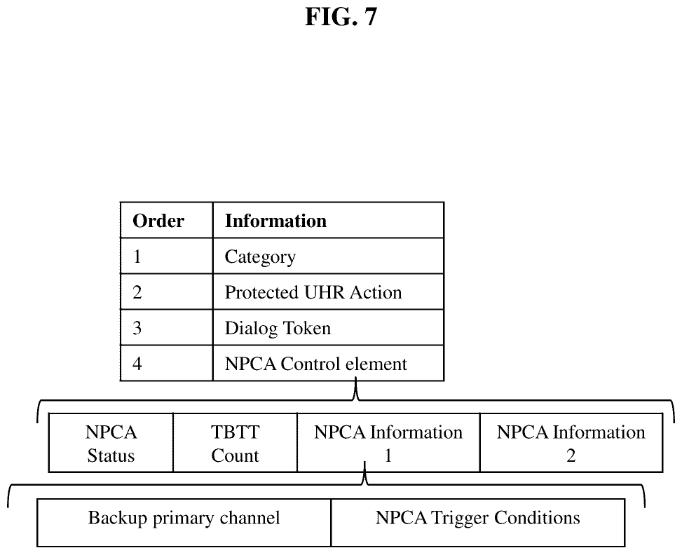

FIG. 7 illustrates a NPCA notification frame and a NPCA control element/field in accordance with an embodiment. The frame includes a category field, a protected UHR action field, a dialog token field, and an NPCA control element field. The category field may provide category information for the frame. The protected UHR action field may provide information to differentiate the protected UHR action frame formats. The dialog token may provide a unique identifier used to match requests with their corresponding responses in various management frame exchanges, ensuring proper synchronization and tracking of communication. As illustrated in FIG. 7, the NPCA Notification frame or NPCA Control element or field can include a NPCA status field, a Target Beacon Transmission Time (TBTT) count field, and one or more NPCA information fields, as illustrated, NPCA information 1 field, a NPCA information 2 field. Each NPCA information field may include a backup primary channel field and a NPCA trigger conditions field.

The NPCA Status field may indicate whether the NPCA is being enabled, disabled or updated. The TBTT Count field may indicate the remaining time after which the change of NPCA status takes place. This can be measured, for example, in target beacon transmit times (TBTTs). Each NPCA Information field may further include an indication of the backup primary channel corresponding to NPCA operation, one or more NPCA parameters such as the NPCA Channel Access Delay, Maximum NPCA Channel Access Delay, NPCA Transition Delay, Maximum NPCA Transition Delay, and a NPCA trigger conditions field that includes a list of rules for triggering the NPCA channel switch as described herein.

In some embodiments, when enabling NPCA, the NPCA Status can be set to “Enable”, the TBTT Count field may indicate when the enablement will take place and there may be one NPCA Information field that indicates the parameters after the enablement. When disabling NPCA, the NPCA Status can be set to “Disable”, the TBTT Count field may indicate when the disablement will take place and there may be one NPCA Information field that indicates the current NPCA parameters before the disablement. After the NPCA is disabled, the NPCA Control element or field may no longer be included in the beacon frames. When NPCA is currently active and no end time is applicable, the NPCA Status field indicates enable, but with a TBTT Count field set to a value of 0. When updating one NPCA parameter set with another one, the NPCA Status may be set to “update”, and two NPCA Information fields may be included, where the first one is the currently active schedule which is scheduled to be disabled and the second one is the updated schedule which is to be enabled. In some embodiments, the second NPCA Information field may be a compressed field, which can skip one or more of the fields that are the same as the current schedule, e.g. some of the rules for NPCA channel switch among others. There can be a bitmap in the second NPCA Information field indicating which of the fields are not skipped. Any skipped field is assumed to have the same value as the current (first) NPCA Information field.

In some embodiments, an indication of change in NPCA status (e.g., enable, disable, or update) may be provided for sufficient time before the change happens to ensure each associated UHR STA affiliated with the AP would have received the indication. The change of NPCA status can be considered a critical update by the AP.

In some embodiments, the AP performing NPCA may disable spatial reuse mechanisms in its own BSS. This may be applicable to one or both of overlapping basic service set packet detect (OBSS PD) mechanism and the Parameterized Spatial Reuse (PSR) mechanism. This can be done, for example, by setting the PSR Disallowed subfield and Non-SRG OBSS PD SR Disallowed subfield of the SR Control field of the Spatial Reuse Parameter Set element transmitted by the AP to 1, respectively. In some embodiments, the AP can set the HESIGA_Spatial_reuse_value15_allowed subfield of the SR Control field to 1. Accordingly, the AP may not enable NPCA operation if any type of spatial reuse is enabled in its BSS.

In some embodiments, the AP performing NPCA may have some form of spatial reuse enabled, and may correspondingly set some NPCA trigger conditions such that the NPCA switch does not happen when there is a potential chance of spatial reuse-based transmission within the BSS. This can be, for example, setting a minimum value of the received PPDU RSSI for triggering the NPCA switch. In another example, this can be realized by setting a rule that NPCA is only triggered if the observed OBSS transmission is a HE+PPDU that disallows spatial reuse, as indicated in the Spatial Reuse fields of the SIG A field of the PPDU.

In some embodiments, the AP may not enable NPCA if it has some associated STAs which belong to a specific older WiFi generations, e.g. pre-802.11ax (before WiFi-6).

Parameter indication by an AP after enabling NPCA in accordance with this disclosure is described herein. In some embodiments, while an AP is operating in NPCA mode, it may periodically indicate some of the currently operational NPCA parameters in Beacon frames or other broadcast frames that it transmits. The indicated parameters may include one or more of the following fields. The current status of NPCA operation (active, inactive, enabled, disabled, among others). An indication of one or more NPCA parameters such as the NPCA backup primary 20 Mhz channel, NPCA Channel Access Delay, Maximum NPCA Channel Access Delay, NPCA Transition Delay, Maximum NPCA Transition Delay, among others. A list of rules for NPCA channel switch along with applicable parameters as described herein. An indication of the type of NPCA switches allowed (NAV duration based NPCA or PPDU duration based NPCA, among others). A list of rules for channel access on the backup channel during NPCA operation.

In some embodiments, these parameters can be indicated in the UHR Operation element of the Beacon frame. In some embodiments, some NPCA parameters like NPCA Status, and the NPCA Backup Primary Channel can be indicated in the UHR Operation element.

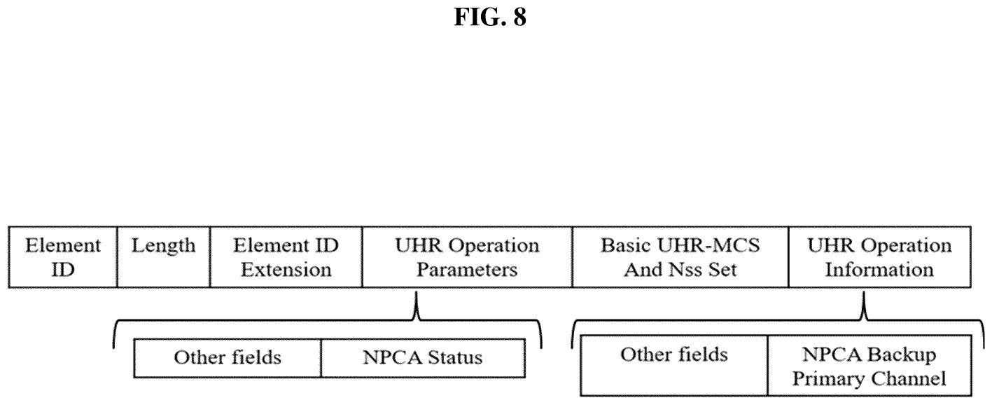

FIG. 8 illustrates a UHR Operation element with NPCA parameters in accordance with an embodiment. The element includes an element ID field, a length field, an element ID extension field, a UHR operation parameters field, a basic UHR-MCS and NSS set field, and a UHR operation information field. The UHR operation parameters field may include an NPCA status field. The UHR operation information field may include other fields and a NPCA backup primary channel field.

The element ID field may provide an identifier for the element. The length field may provide length information for the element. The element ID extension field may provide identifier extension information. The UHR operation parameters field may provide UHR operation parameters information. The Basic UHR-MCS and NSS set field may provide modulation and coding scheme (MCS) information and number of spatial streams (NSS) information. The UHR operation information field may provide UHR operation information. The UHR operation parameters field may include the other fields and a NPCA status field. The NPCA status field may provide status information for NPCA operations.

The UHR operation information field may include other fields and an NPCA backup primary channel field. The NPCA backup primary channel field may provide NPCA backup channel information. In some embodiments, other long-term NPCA parameters, such as the NPCA Channel Access Delay, Maximum NPCA Channel Access Delay, NPCA Transition Delay, Maximum NPCA Transition Delay, NAV Duration Threshold for NPCA Switch, among others, may not be carried by the NPCA AP in every UHR Operation element included in Beacon frames, to reduce the overhead. In some embodiments, these parameters can be indicated in a new element which may be referred to herein as the NPCA Parameters element, which is transmitted by the AP in Beacon frames.

Non-AP STA indication of enabling NPCA operation in accordance with this disclosure is described herein. In some embodiments, if a non-AP STA indicates support for NPCA operation, and the AP has enabled NPCA operation as described herein, then it may be implicitly assumed that the non-AP STA will perform NPCA operation. In some embodiments, a non-AP STA may also verify if the non-AP STA meets the required conditions for participating in the NPCA operation, as indicated by the AP, before enabling NPCA operation. Such conditions may be related to, for example, bandwidth supported by the non-AP STA, the NPCA Channel Access Delay, NPCA Transition Delay for the non-AP STA, the Maximum NPCA Switch Delay indicated by the AP, the Maximum NPCA Channel Access Delay indicated by the AP, among others. In some embodiments, the non-AP STA may transmit a frame to the AP, which may be referred to as a NPCA Support Notification frame, to enable or disable its participation in NPCA operation. In some embodiments, the non-AP STA may also transmit this frame to indicate any change of its NPCA parameters or NPCA channel switch triggering conditions. This frame may include an indication of one or more of the following. The purpose of signaling, including enable, disable or Update of NPCA operation, carried in, for example, an NPCA Status field. An indication of one or more NPCA parameters that are applicable to the non-A STA. A list of STA-specific trigger conditions for NPCA channel switch, along with applicable parameters as described later in the disclosure.

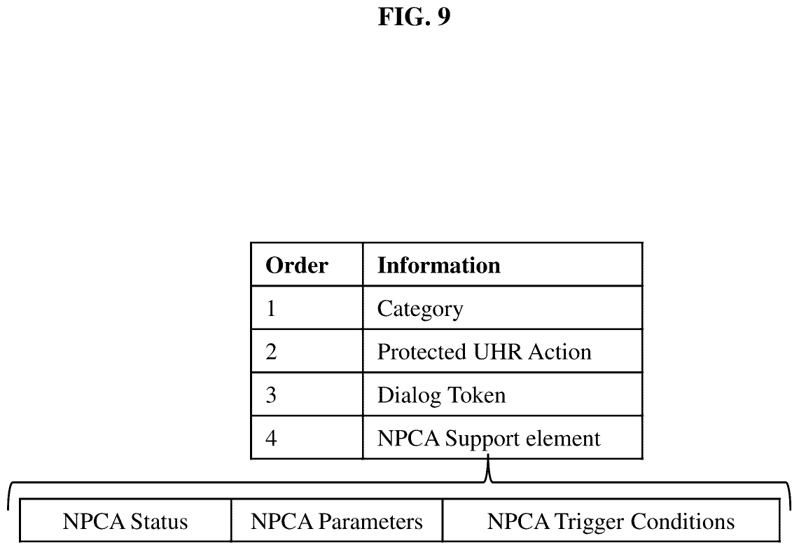

FIG. 9 illustrates an NPCA support notification frame in accordance with an embodiment. The frame may include a category field, a protected UHR field, a dialog token field, and an NPCA support element field. The NPCA support element field may include a NPCA status field, an NPCA parameters field, and a NPCA trigger conditions field.

The category field may provide category information for the frame. The protected UHR action field may provide information to differentiate the protected UHR action frame formats. The dialog token may provide a unique identifier used to match requests with their corresponding responses in various management frame exchanges, ensuring proper synchronization and tracking of communication.

The NPCA status field may include the purpose of signaling, including enable, disable or Update of NPCA operation. The NPCA parameters field may provide one or more NPCA parameters that are applicable to the non-AP STA. The NPCA trigger conditions field may provide a list of STA-specific trigger conditions for NPCA channel switch, along with applicable parameters as described later in the disclosure.

In some embodiments, the indications in the NPCA Support Notification frame may be applicable upon successful transmission of the frame to the AP. In certain embodiments, the indication in the NPCA Support Notification frame may be applicable after the AP sends a response NPCA Support Notification frame.

Rules for triggering NPCA channel switch in accordance with this disclosure is described herein. In some embodiments, some non-configurable triggering conditions for the NPCA channel switch when a transmission is observed to occupy the primary channel of the AP/BSS may be predefined, for example by a standards (e.g., IEEE 802.11 standards). In some embodiments, these triggering conditions may be based on, one or more of the following.
1) PPDU duration: The duration of the PPDU observed on the primary channel. This can be obtained from, for example, the L-SIG field of the legacy PHY header. In some embodiments, the PPDU duration may be obtained from the MAC frame header.
2) NAV duration: The NAV duration that is set by the PPDU observed on the primary channel. For pre-11ax PPDUs, this indication can be obtained from the Duration field of the MAC frame header, while for 11ax and beyond PPDUs, this indication can be obtained from the TXOP subfield of the HE-SIG-A2/U-SIG1 field of the PHY header. In some embodiments, the NAV duration may refer to a TXOP duration. In particular, a NAV may use a TXOP duration to determine when a station may transmit, such that the NAV timer is set based on the TXOP duration, indicating how long a channel is reserved for a particular station.
3) Inter-BSS classifiability: The ability to reliably classify the PPDU observed on the primary channel as belonging to a different BSS. Note that in certain pre-11ax frames such as clear-to-send (CTS) frames, the transmit address is not present, so there can be scenarios where it is unclear if the frame is an intra-BSS PPDU or an inter-BSS PPDU.
4) PPDU BW determinability: The ability to determine the bandwidth occupied by the PPDU observed on the primary channel. This can be done, for example, to check if the backup primary channel is also occupied by the PPDU. Note that in some non-HT duplicate PPDUs, such as the CTS frames, it is not possible to determine the validity of the RXVECTOR parameter CH_BANDWIDTH_IN_NON_HT and, thus, the bandwidth may not be reliably determined.
5) PPDU format: The format of the PPDU may also be used to determine if it can trigger NPCA channel switch. For example, HT and VHT PPDUs may be excluded from NPCA channel switch trigger conditions since they do not carry NAV information in the PHY header.
6) The expected duration of NPCA switch: This is the time within the observed PPDU on the primary channel, counting from the start of the PPDU reception, by when the determination to perform NPCA switch is to be made. This duration can be represented by T* and for different switch cases can be set to, for example, the PHY header duration, PHY header duration+E where E is some pre-determined additional time, PHY header+MAC header duration, the PPDU duration, PHY header+1^{st} MAC frame duration, PHY header+MAC header duration+D where D is the additional time required for forwarding the MAC header to the MAC layer by the PHY layer and any additional processing, among others.
7) MAC frame included: In some cases, some specific triggering rules may be applicable depending on the MAC frame that is included in the observed PPDU on the primary channel. Such MAC frame specific rules can be applied, for example, for Multi-User Request-To-Send (MU-RTS) frame, RTS frame, Clear-To-Send (CTS) frame, control frames, among others.
8) Presence of aggregation: This is an indication of whether the payload of the PPDU is an MPDU or an aggregated M PDU.
9) Spatial Reuse allowance: In some cases, the triggering may depend on whether spatial reuse over the transmission observed on the primary channel is allowed or not. For HE+PPDUs, this is indicated for example in the Spatial Reuse field(s) in the SIG A field of the PPDU. In some embodiments, if spatial reuse over the transmission is allowed and the AP has enabled spatial reuse within the BSS, then the transmission may not be eligible for NPCA triggering.
10) Observation of a preceding control frame: This may be an indication of whether a control frame that is expected to precede the observed transmission on the primary channel has also been observed on the primary channel. In some embodiments, such as when the observed transmission is a control response frame, such as a CTS frame or a trigger response frame sent in a pre-HE PPDU format, the NPCA trigger condition may depend on whether the preceding control frame, e.g., RTS, MU-RTS, among others, was also received. In some embodiments, where an obserbed OBSS PPDU is the first frame after a control frame exchange, where at least one of the control frames is also received, the NPCA switch conditions may be different.

In some embodiments, the pre-defined triggering conditions may include one or more of the following requirements. Requirements on PPDU duration or NAV duration of the PPDU observed on the primary channel (PCH) in accordance with some embodiments are described herein. Some embodiments may require PPDU duration>Threshold1, where the PPDU duration can be from the L-SIG field or, in this case, PPDU duration based NPCA may be performed if other rules are satisfied. T* can be the PHY header+MAC header duration.

In some embodiments, if PPDU is in a pre-HE format, require NAV duration>Threshold2, where the NAV duration can be from the MAC header, or, in this case, NAV duration based N PCA may be performed if other rules are satisfied. T* can be the PPDU duration.

In some embodiments, if PPDU is in HE+format, require NAV duration+PPDU duration−PHY header duration>Threshold3, where the NAV duration can be from the PHY header, in this case, NAV duration based NPCA may be performed if other rules are satisfied. T* can be the PHY header duration.

Requirements on the TA/RA/BSS Color of PPDU observed on the PCH in accordance with some embodiments are described herein. The PPDU should be capable of being classified as inter-BSS PPDU before the switch determination time T *. For example, if PPDU is in pre-HE format, neither transmit address (TA) nor receive address (RA) of the OBSS PPDU should match the BSSID of the BSS or any of the other BSSs in the same multiple BSSID set or co-hosted BSSID set to which its BSS belongs or the wildcard BSSID. If OBSS PPDU is in HE+format, BSS color should not match own BSS. Note that CTS/CTS-to-self may not be classifiable as inter/intra BSS PPDU in some cases. In some embodiments, a check for intra-BSS NAV=0 may be used as the trigger requirement. The PPDU transmission BW should not overlap with the NPCA backup PCH. In some embodiments, a 20/40/80/160 MHz channel occupied by the PPDU may be identified by the STA based on a bandwidth field in the PHY preamble of the PPDU and the channel allocation in the corresponding band, and the STA may determine that the channel occupied by the PPDU does not overlap with he NPCA primary channel.

In some embodiments, if the OBSS transmission is in a non-HT duplicate format, Bandwidth Signaling TA is required or the bandwidth should be signaled in the MAC frame by the switch determination time T *. Note that for CTS (without RTS observed), it may not be known if RX parameter CH_BANDWIDTH_IN_NON_HT is valid. Hence it may not be eligible to trigger NPCA switch if RTS is not observed. Similarly, for some broadcast frames like MU-RTS sent in non-HT duplicate PPDU format, the bandwidth information may be available in the Common Info field of the frame body. If T* is earlier than this time for a switch rule, then the MU-RTS frame may not be eligible to trigger NPCA switch via that switch rule. Similarly, for beacon frames transmitted in 6 GHz band, they can be sent in non-HT duplicate PPDU and the bandwidth signaling is included within the beacon frame (e.g., MAC frame body). Correspondingly, in some embodiments, beacon frames in 6 GHz band may not be eligible for triggering NPCA switch after the MAC header. In certain embodiments, the AP may indicate the MAC addresses of neighboring A Ps whose operating bandwidth and/or whose beacons do not overlap with the NPCA backup primary channel. In some embodiments, the NPCA switch may be triggered by non-HT duplicate frames with transmit address matching that MAC address list, even if bandwidth signaling is not explicitly obtained by time T*.

Requirements applicable to specific MAC frames in accordance with some embodiments is described herein. In some embodiments, if the MAC frame in the PPDU is an RTS frame, a check for NAV reset procedure may also be applied. In this process, the switch may be performed if a PHY-RXSTART.indication primitive is received at the STA within a NAV Timeout period starting when the MAC receives a PHY-RXEND.indication primitive corresponding to the detection of the RTS frame. In some embodiments, if the observed PPDU includes an initial control frame that solicits a response frame and is sent in non-HT or non-HT duplicate format, then the PPDU may not be used for triggering the NPCA switch. In this case, the switch may be performed after receiving the control response frame. In certain embodiments, if the observed PPDU includes a control response frame, then the reception of the initial control frame that solicited the response frame may be a pre-condition for initiating the NPCA switch.

In some embodiments, Threshold1, Threshold2 and Threshold3 may be parameters predetermined by the standard or they may be parameters indicated by the AP when enabling NPCA operation.

In some embodiments, there may be a relation between the three thresholds, e.g., we may have Threshold1−PHY header duration−MAC header duration=Threshold2=Threshold3, where the MAC header duration is calculated for a fixed MCS level or based on the MCS of the received frame. Correspondingly, one threshold parameter may need to be defined by the standard or indicated by the AP.

In some embodiments, some additional checks may be applicable for some specific trigger conditions. For example, if PPDU is in pre-HE format and NAV duration>Threshold2 is satisfied or if PPDU duration>Threshold1 condition is satisfied, then an additional check may be performed on whether the PPDU format is non-HT or non-HT duplicate PPDU, and/or if the MCS used for the PPDU is below a certain MCS level. This can be, for example, to ensure packet error rate for reception of the PPDU is low.

In some embodiments, if PPDU is in pre-HE format, instead of checking NAV duration >Threshold2, it may be checked if NAV duration+PPDU duration−PHY header duration−Duration of first MAC frame of PPDU>Threshold2. This can be, for example, to handle the case of MAC frame aggregation, e.g., the payload of the PPDU being an aggregated MPDU. In this case, the switching time T* is after the first MAC frame of the Aggregated MAC Protocol Data Unit (AMPDU) including any additional processing delay D for performing Frame Check Sequence (FCS) check. Here NAV duration based NPCA may be used, where NAV is obtained from the duration field of the MAC header of the first MAC frame. The end of the first MAC frame can be identified, for example, from the MPDU Length subfield of the MPDU Delimiter corresponding to the first MAC frame and receiving corresponding number of PHY-DATA.indication (DATA) primitives, or from the start of the delimiter of the second subframe. In some embodiments, the first MAC frame can be the first fragment of a fragmented MAC frame.

In some embodiments, if the PPDU is in HT or VHT format, instead of checking PPDU duration>Threshold1, it may be checked if PPDU Duration−PHY header duration−Duration of first MAC frame of PPDU>Threshold1. This can be, for example, to handle the case of MAC frame aggregation, e.g., the payload of the PPDU being an aggregated M PDU. In this case, the switching time T* is after the first MAC frame of the AM PDU, including any additional processing delay D for performing FCS check. Here PPDU duration based NPCA can be used, where PPDU Duration is obtained from the L-SIG field of the PPDU PHY header. The end of the first MAC frame can be identified, for example, from the MPDU Length subfield of the MPDU Delimiter corresponding to the first MAC frame and receiving corresponding number of PHY-DATA.indication (DATA) primitives, or from the start of the delimiter of the second subframe. In some embodiments, the first MAC frame can be the first fragment of a fragmented MAC frame. In certain embodiments, if the PPDU is in HE or beyond format, the check for PPDU duration>Threshold1 may be skipped and PPDU duration based NPCA may not be used.

In some embodiments, if the PPDU is in pre-HE format and either the Transmitter Address (TA) or Receiver Address (RA) match with other BSSs in the multiple BSSID set or co-hosted BSSID set, the PPDU may still be eligible for triggering NPCA channel switch.

In some embodiments, if the condition PPDU duration>Threshold1 is satisfied but the other two conditions in Step 1 involving NAV duration are not satisfied, then PPDU duration based NPCA may be performed over the transmission. If the conditions NAV duration>Threshold2 (for non-HT format) or NAV duration+PPDU duration−PHY header duration>Threshold3 (for HE+format) are satisfied but the condition PPDU duration>Threshold1 is not satisfied, NAV duration based NPCA may be performed over the transmission. When multiple conditions from Step 1 are simultaneously satisfied, there can be the following. In some embodiments, PPDU duration based NPCA may be performed over the transmission. In some embodiments, NAV duration based NPCA may be performed over the transmission. In some embodiments, the AP may determine the type of NPCA it wants to use based on its implementation, and after performing the NPCA switch the AP may indicate the selected duration value in the initial frame of the frame exchange on the NPCA backup primary channel. In some embodiments, the AP may provide an explicit indication of the type of NPCA that will be used for each type of NPCA triggering transmission observed on the primary channel. For example, for HE+PPDUs, the AP may indicate if either NAV duration based NPCA will be used or PPDU duration based NPCA will be used. This indication from the AP can be carried during the NPCA enablement or update process.

In some embodiments, a STA that has enabled NPCA operation can perform the NPCA switch only if the receive (RX) power from the OBSS PPDU as observed by the STA is above a certain threshold, e.g., −62 dBm. In some embodiments, this power threshold may apply to the non- AP STAs associated with the AP but not to the AP itself. This can be, for example, to ensure that when the non-AP STA performs the NPCA switch, the AP also performs the switch with a high likelihood. In some embodiments, the power threshold may not be a constant for all non-AP STAs but rather it may be a function of the received signal strength between the serving AP and the non-AP STA: RSSI_{AP-STA} or the pathloss between the serving AP and the non-AP STA PL_{AP-STA}. In some embodiments, there may be a Power Threshold=A−B×RSSI_{AP-STA} or Power Threshold=C+D×PL_{AP-STA}, where A, B, C, D are some constants defined by the standard. More generally, there may be a Power Threshold=f(RSSI_{AP-STA}, PL_{AP-STA}), where f(.) is a function predefined by the standard.

In some embodiments, if the OBSS transmission is in a non-HT duplicate format and is an initial control frame that is expected to be part of a control frame exchange, the NPCA switch time T* may be after detecting the PHY header of the first frame that follows after the control frame exchange. In other words, NAV duration based NPCA may be triggered by an OBSS non-HT PPDU that follows after a control frame exchange. In some embodiments, if the OBSS transmission is in a non-HT duplicate format and is a control response frame that is expected to be part of a control frame exchange, the NPCA switch time T* may be at the expected time of reception of the PHY header of the first frame that follows after the control frame exchange.

In some embodiments, one or more conditions may be skipped. In some embodiments, once a PPDU is detected on the primary channel, energy detection on the backup primary channel can be performed to detect if the backup channel is idle before performing the NPCA switch. Thus, there may not be a need to obtain the bandwidth of the PPDU on the primary channel accurately from the header fields of the PPDU.

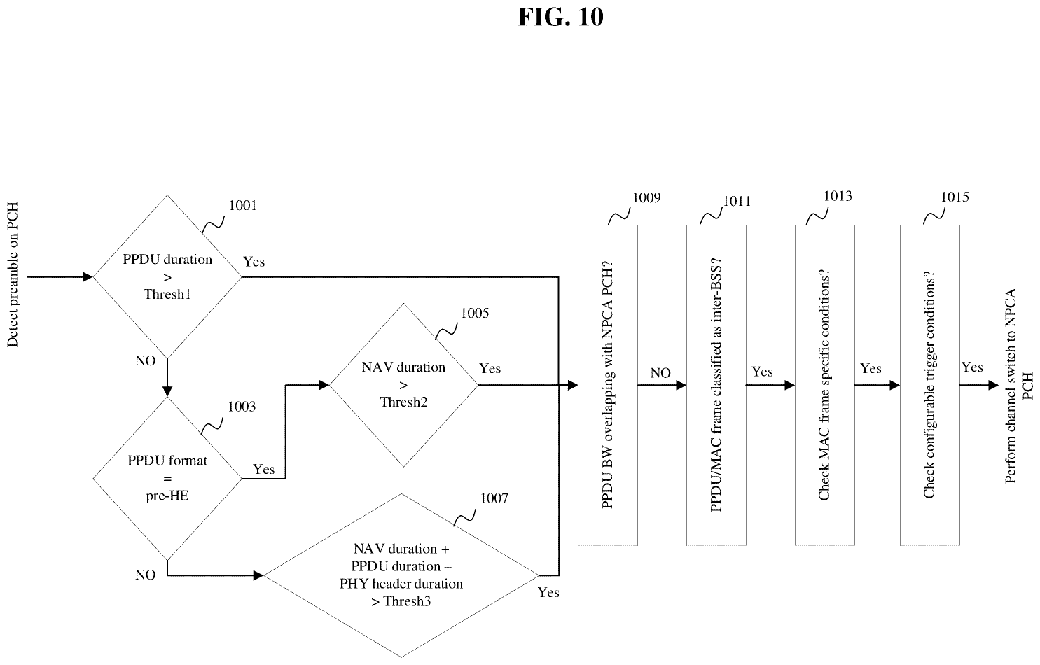

FIG. 10 illustrates a flow chart of rules to be applied to the PPDU observed on the primary channel (PCH) to test if they can trigger channel switch to the backup PCH in accordance with an embodiment. In some embodiments, the ordering of the spec defined triggering conditions can be different. As illustrated, the conditions may include one or more of the following. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a non-AP STA, such as the non-AP STA illustrated in FIG. 3.

In operation 1001, if PPDU is in HE+format, require NAV duration+PPDU duration−T*>Threshold1. Here NAV duration based NPCA may be performed, the NAV duration can be from the PHY header, and T* indicates time of switch determination, e.g., T*=PHY header duration.

In operation 1003, if PPDU is in pre-HE format, the process proceeds to operation 1005 that requires NAV duration+PPDU duration−T*>Threshold2. Here NAV duration based NPCA may be performed, the NAV duration can be from the MAC header and T* indicates time of switch determination, e.g., T*=PPDU duration.

In operation 1007, if PPDU is in pre-HE format, require PPDU duration−T*>Threshold3. Here PPDU duration based NPCA may be performed, the PPDU duration can be from the L-SIG field and T* indicates time of switch determination, e.g., T*=PHY header duration+MAC header duration. In some embodiments, T*=PHY header duration+duration of MAC header up to a specific information field like the Address 2 field.

In operation 1009, determine whether requirements that the PPDU transmission BW should not overlap with the NPCA backup PCH are satisfied, and if these are satisfied, the process proceeds to operation 1011. If the OBSS transmission is in a non-HT duplicate format, Bandwidth Signaling TA is required or the bandwidth should be signaled in the MAC frame by the switch determination time T*. Note that for CTS (without RTS observed), it may not be known if RX parameter CH_BANDWIDTH_IN_NON_HT is valid. Hence it may not be eligible to trigger NPCA switch if RTS is not observed. Similarly, for some broadcast frames like MU-RTS sent in non-HT duplicate PPDU format, the bandwidth information may be available in the Common Info field of the frame body. If T* is earlier than this time for a switch rule, then the MU-RTS frame may not be eligible to trigger NPCA switch via that switch rule. Similarly, for beacon frames transmitted in 6 GHz band, they can be sent in non-HT duplicate PPDU and the bandwidth signaling is included within the beacon frame (e.g., MAC frame body). Correspondingly, in some embodiments, beacon frames in 6 GHz band may not be eligible for triggering NPCA switch after the MAC header. In certain embodiments, the AP may indicate the MAC addresses of neighboring A Ps whose operating bandwidth and/or whose beacons do not overlap with the NPCA backup primary channel. Accordingly, the NPCA switch may be triggered by non-HT duplicate frames with transmit address matching that MAC address list, even if bandwidth signaling is not explicitly obtained by time T*.

In operation 1011, determine whether requirements on the TA/RA/B SS Color of PPDU observed on the PCH are satisfied, and if these are satisfied, the process proceeds to operation 1013. The PPDU should be classified as inter-BSS PPDU before the switch determination time T*. Note that checking for intra-BSS NAV=0 may not be sufficient. In addition, CTS or CTS-to-self may not be classifiable as inter/intra BSS PPDU in some cases. In some embodiments, a check for intra-BSS NAV=0 may be used as the trigger requirement.

In operation 1013, determine whether requirements applicable to specific MAC frames are satisfied, and if satisfied, the process proceeds to operation 1015. If the MAC frame in the PPDU is an RTS frame, a check for NAV reset procedure may also be applied. In this process, the switch may be performed if a PHY-RXSTART.indication primitive is received at the STA within a NAV Timeout period starting when the MAC receives a PHY-RXEND.indication primitive corresponding to the detection of the RTS frame. In some embodiments, if the observed PPDU includes an initial control frame that solicits a response frame and is sent in non-HT or non-HT duplicate format, then the PPDU may not be used for triggering the NPCA switch. In this case, the switch may be performed after receiving the control response frame. In certain embodiments, if the observed PPDU includes a control response frame, then the reception of the initial control frame that solicited the response frame may be a pre-condition for initiating the NPCA switch.

In operation 1015, the configurable trigger conditions are checked and if satisfied, the process performs channel switch to NPCA PCH.

In some embodiments, Threshold1, Threshold2 and Threshold3 may be parameters predetermined by the standard or they may be parameters indicated by the AP when enabling NPCA operation.

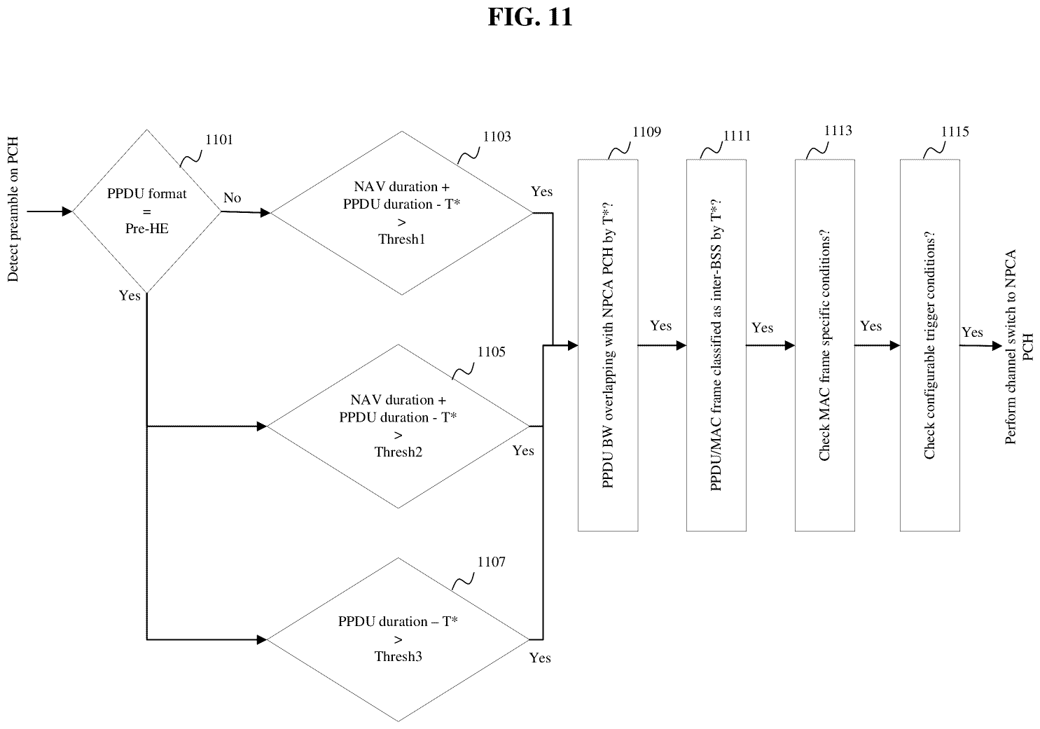

FIG. 11 a flow chart of an example process of the rules to be applied to a PPDU observed on a primary channel (PCH) to test if they can trigger channel switch to the backup PCH in accordance with an embodiment. Note that the sequences of the checks in FIG. 11 are for illustration only and the order of the checks may be different in an implementation. Although one or more operations are described or shown in a particular sequential order, in other embodiments the operations may be rearranged in a different order, which may include performance of multiple operations in at least partially overlapping time periods. The flowchart depicted in FIG. 11 illustrates operations performed in a non-AP STA, such as the non-AP STA illustrated in FIG. 3. In some embodiments, there may be a relation between the three thresholds (e.g., Threshold1=Threshold2=Threshold3, among other variations). In some embodiments, some additional checks may be applicable for some specific trigger conditions. For example, if PPDU is in pre-HE format, then an additional check may be performed on whether the PPDU format is non-HT or non-HT duplicate PPDU, and/or if the MCS used for the PPDU is below a certain MCS level. This can be, for example, to ensure packet error rate for reception of the PPDU is low.

In operation 1101, if the PPDU is not in a pre-HE format, then proceed to operation 1103 where NAV duration+PPDU duration−T*>Threshold1 is checked. If the condition is satisfied, the process proceeds to operation 1109.

In operation 1101, if PPDU is in pre-HE format, then in operation 1105 when checking NAV duration+PPDU duration−T*>Threshold2, the value of T* may be set to PHY header duration+Duration of first MAC frame of PPDU+D, where D is a predetermined constant. This can be to handle the case of MAC frame aggregation, e.g., the payload of the PPDU being an aggregated M PDU. In this case, the switching time T* is after the first MAC frame of the AM PDU, including any additional processing delay D for performing FCS check. Here NAV duration based NPCA is used where NAV is obtained from the duration field of the MAC header of the first MAC frame. The end of the first MAC frame can be identified, for example, from the MPDU Length subfield of the MPDU Delimiter corresponding to the first MAC frame and receiving corresponding number of PHY-DATA.indication (DATA) primitives, or from the start of the delimiter of the second subframe. In some embodiments, this first MAC frame can be the first fragment of a fragmented MAC frame. If the condition in operation 1105 is satisfied, the process proceeds to operation 1109.

In operation 1107, if the PPDU is in HT or VHT format, when checking for PPDU duration−T*>Threshold3, the value of T* may be set to PHY header duration+Duration of first MAC frame of PPDU+D, where D is a predetermined constant. This can be, for example, to handle the case of MAC frame aggregation, e.g., the payload of the PPDU being an aggregated MPDU. In this case, the switching time T* is after the first MAC frame of the AMPDU, including any additional processing delay D for performing frame check sequence (FCS) check. Here PPDU duration based NPCA can be used, where PPDU Duration is obtained from the L-SIG field of the PPDU PHY header. The end of the first MAC frame can be identified, for example, from the MPDU Length subfield of the MPDU Delimiter corresponding to the first MAC frame and receiving corresponding number of PHY-DATA.indication (DATA) primitives, or from the start of the delimiter of the second subframe. In some embodiments, this first MAC frame can be the first fragment of a fragmented MAC frame. If the condition in operation 1107 is satisfied, the process proceeds to operation 1109.

In operation 1009, the process determines whether requirements that the PPDU BW non-overlapping with the NPCA PCH by T* are satisfied, and if these conditions are satisfied, the process proceeds to operation 1111.

In operation 1011, the process determines whether PPDU/MAC frame classified as inter-BSS by T* is satisfied, and if these are satisfied, the process proceeds to operation 1113.

In operation 1013, the process determines whether requirements applicable to specific MAC frames are satisfied, and if these are satisfied, the process proceeds to operation 1115.

In operation 1015, the configurable trigger conditions are checked and if satisfied, the process performs channel switch to NPCA PCH.

In some embodiments, if the PPDU is in pre-HE format and either the TA or RA match with other BSSs in the multiple BSSID set or co-hosted BSSID set, the PPDU may still be eligible for triggering NPCA channel switch.

In some embodiments, when the PPDU is in pre-HE format and the condition PPDU duration−T*>Threshold3 is checked, the value of T* can be set to T*=PHY header duration+D, where the value of D is determined by when the desired MAC header information for the received PPDU is forwarded by the PHY layer to the MAC layer. This forwarding can be done, for example, via PHY-DATA.indication(DATA) primitives that include the MAC header information. For example, if the whole MAC header information is required which may include up to 36 octets, the value of D can be the time of indication of the 36^{th} PHY-DATA.indication (DATA) primitive from the received PPDU on the primary channel+any processing delay. In some embodiments, if the Address 1 and Address 2 information is desired from the MAC header which may be available in the first 16 octets, the value of D can be the time of indication of the 16^{th} PHY-DATA.indication(DATA) primitive from the received PPDU on the primary channel+any processing delay. There can also be some other mapping relationship between number of octets of the MAC header required and N, the number of PHY-DATA.indication(DATA) primitives to wait. This value of N can also be a parameter indicated by the AP for NPCA access within its BSS. In the case where different receiver implementations may need different time to forward the MAC header information to the MAC layer, the value of D can be chosen to be a value larger than most implementations. In some embodiments, a new PHY primitive may be defined which is generated when the MAC address is forwarded by the PHY to the MAC layer.

In some embodiments, the sequence of checks for the trigger conditions may be performed based on one or more of the following conditions. A condition may include the sequence or chronology of the information availability in the received frame. For example, in a received frame the PPDU duration may be available first, followed by the PPDU format and then PPDU bandwidth. If the PPDU format is pre-HE, the inter-BSS classification information and the NAV information may be available later in the M A C header, and they may be validated at the end of the first MAC frame of the PPDU via the FCS check field. If the PPDU format is HE, the inter-BSS classification information and the NAV information may be available in the PHY header in the HE-SIG-A2 field. If the PPDU format is EHT or beyond, the inter-BSS classification information and the NAV information may be available in the PHY header in the U-SIG1 field.

A condition may include the complexity involved in the checking of the rule. For example, the inter-BSS classification in the pre-HE PPDU formats may be more complicated than other rules. In some embodiments, rules for which information is available earlier and the rules which can be checked more easily may be checked first.

In some embodiments, where the PPDU is a pre-HE PPDU and NAV duration-based switch is being performed, the switch determination can be made before the end of the PPDU. This can be if an intermediate frame check sequence (FCS) or preliminary FCS is carried in the frame, and all the NPCA supporting STAs in the BSS are capable of supporting intermediate FCS or preliminary FCS, then T* can be the duration starting from the beginning of the PPDU, and counting till and including the location of the intermediate or preliminary FCS (whichever occurs first).

In some embodiments, it may be assumed that the NAV duration indicated in a PPDU is counted from the end of the PPDU, e.g., it also excludes the PPDU duration. In some embodiments, where NAV duration indicated in a PPDU is counted from the beginning time of the PPDU, then in the above examples, PPDU duration may be subtracted from the NAV duration before applying the rules.

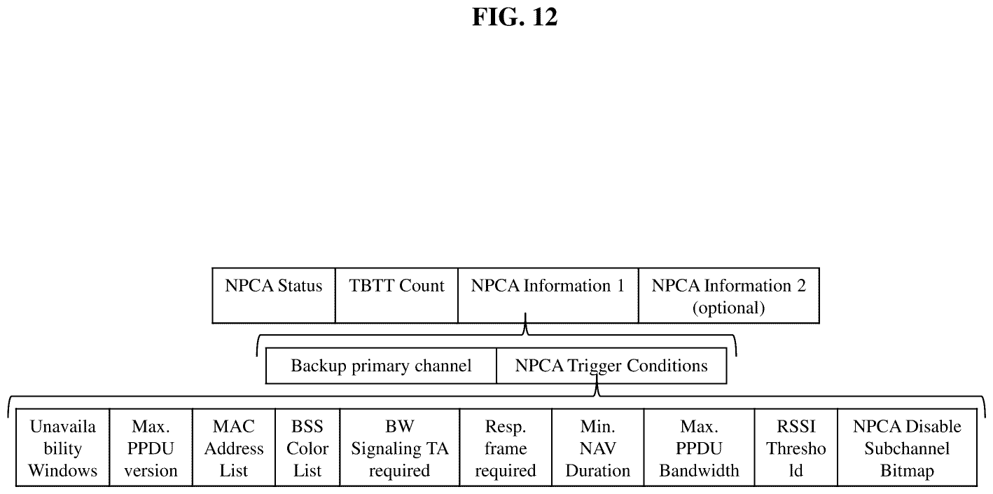

AP indicating configurable trigger conditions for NPCA channel switch in accordance with this disclosure is described herein. In some embodiments, when the Network Allocation Vector (NAV) is set on the primary 20 MHz channel by a transmission that is not from the current BSS, a specific set of rules may be applicable to determine if the switch to the backup channel should be performed. Some of these rules may be pre-defined in the spec, while other rules along with associated rule parameters may be configurable and can be indicated by the AP during enablement/update of NPCA via broadcast signaling, as depicted in FIG. 7 and FIG. 12 in accordance with an embodiment. The rules for switch to backup primary channel may be based on several parameters of the Physical Protocol Data Unit (PPDU) that sets the NAV on the primary channel, including: the format of the PPDU; the Transmit Address (TA) of the PPDU; the Receive Address (RA) of the PPDU; the BSS Color of the PPDU; the type of Medium Access Control (MAC) frame included within the PPDU; the PPDU bandwidth (BW); whether the PPDU BW is signaled using the SERVICE bits (if it is in a non-HT duplicate format); the NAV duration set by the PPDU; the duration of the PPDU determined from the L-SIG field; the RX power of the PPDU as seen by the AP; the RX power of the PPDU as seen by a non-AP STA; whether a response frame or a follow up frame to the initial PPDU has also been detected on the medium; the start and end time of the NAV set by the PPDU; or whether spatial reuse over the PPDU is allowed or not. For HE+PPDUs, this is indicated for example in the Spatial Reuse field(s) in the SIG A field of the PPDU.

FIG. 12 illustrates a NPCA Trigger Conditions field of the NPCA information field of an NPCA Control element in accordance with an embodiment. The NPCA control element may include an NPCA status field, a TBTT count field, an NPCA information 1 field, and a NPCA information 2 field (optional). The NPCA information 1 field may include a backup primary channel field, and a NPCA trigger conditions field. The backup primary channel field may indicate a channel number of a channel within the BSS bandwidth that corresponds to the channel that the NPCA AP and its associated NPCA non-AP STAs switch to perform NPCA operation.

The NPCA trigger conditions field may include an unavailability windows field, a maximum PPDU version field, a MAC address list field, a BSS color list field, a BW signaling TA required field, a response frame required field, a minimum NAV duration field, a maximum PPDU bandwidth field, a RSSI threshold field, and a NPCA disable subchannel bitmap field.

The NPCA Status field may indicate whether the NPCA is being enabled, disabled or updated. The TBTT Count field may indicate the remaining time after which the change of NPCA status takes place. This can be measured, for example, in target beacon transmit times (TBTTs). Each NPCA Information field may further include an indication of the backup primary channel corresponding to NPCA operation, one or more NPCA parameters and a NPCA trigger conditions field that includes a list of rules for triggering the NPCA channel switch. The unavailability windows field may provide unavailability information.

In some embodiments, the NPCA channel switch may be performed if the OBSS PPDU is transmitted below a specific Physical Layer (PHY) version, e.g., in a non-HT or non-HT duplicate PPDU format. Such a case may happen, for example, when the AP is operating in some power save modes during which it has limited PHY decoding capabilities. This indication can be carried in the Max. PPDU Version field illustrated in FIG. 12. This can also be called Max. PHY Version field.

In some embodiments, the NPCA channel switch may be performed if the OB SS PPDU carries a certain type of MAC frame, e.g. RTS frame, CTS frame, trigger frame, among others.

In some embodiments, the NPCA channel switch may be performed if the RA or the TA of the OBSS PPDU matches a list of MAC addresses that is disclosed by the AP. These can be the MAC addresses of a few neighboring A Ps that operate OBSSs in close vicinity to the AP. The list may include both transmitted and non-transmitted BSSID MAC addresses of a neighboring AP. A change in the value of the individual or group bit of the MAC address may be ignored. The list may be prepared based on the received power from the OBSS AP being above a certain threshold, or the OBSS AP's operating bandwidth not overlapping with the backup primary channel of the AP among others. The list can be carried in the MAC Address List field illustrated in FIG. 12.

In some embodiments, the NPCA channel switch may be performed over an observed PPDU in non-HT duplicate format that does not include bandwidth signaling, if the RA or the TA of the OBSS PPDU matches a list of MAC addresses that is disclosed by the AP. These can be the MAC addresses of a few neighboring A Ps that operate OBSSs in close vicinity to the AP. The list may include both transmitted and non-transmitted BSSID MAC addresses of a neighboring AP. A change in the value of the individual or group bit of the MAC address may be ignored. The list may be prepared based on the received power from the OBSS AP being above a certain threshold and the OBSS AP's operating bandwidth not overlapping with the backup primary channel of the AP, or the beacons of the OBSS AP not overlapping with the backup primary channel, among others.

In some embodiments, the NPCA channel switch may be performed if the OBSS PPDU format is HE/EHT/UHR among others, and the BSS color indicated in the PHY header matches a list of BSS colors that is disclosed by the AP. These can be the BSS Colors of a few neighboring OBSSs in close vicinity to the AP. The list can be carried in a BSS Color List field in FIG. 12.

In some embodiments, the NPCA channel switch may be performed if the OBSS PPDU allows identification of the PPDU bandwidth by a 20 MHz UHR device operating on the AP's primary channel. This is possible unless the format is non-HT duplicate with the SERVICE bits not indicating the bandwidth (i.e., bandwidth signaling TA is not used). This condition can be indicated in the Bandwidth Signaling TA Required field in FIG. 12.

In some embodiments, the NPCA channel switch may be performed if the OBSS PPDU allows identification of the PPDU bandwidth by a 20 MHz device operating at or above a certain WiFi generation, e.g., non-HT.

In some embodiments, the NPCA channel switch may be performed if the OBSS PPDU bandwidth is not larger than a certain threshold, such as 80 MHz. This can be, for example, to ensure that there are sufficient RUs available after switching to the backup primary channel and/or if the OBSS PPDU bandwidth does not overlap with the backup primary channel of the AP. This can be indicated in the Max PPDU Bandwidth field illustrated in FIG. 12.

In some embodiments, the NPCA channel switch may be performed if the OBSS PPDU allows NAV setting by a 20 MHz UHR device operating on the AP's primary channel. This is possible unless the PPDU format is HT with a bandwidth of 40 MHz.

In some embodiments, the NPCA channel switch may be performed if the OBSS PPDU allows NAV setting by the PPDU by a 20 MHz device operating above a certain WiFi generation, e.g., non-HT.

In some embodiments, the NPCA channel switch may be performed if the NAV set by the OBSS PPDU is above a certain threshold, such as 500 μs or 1 ms. The threshold can be carried in the Minimum NAV Duration field illustrated in FIG. 12. If the OBSS PPDU format is before HE then the threshold should be applied to the NAV obtained from the Duration field of the MAC header. If the OBSS PPDU is HE/EHT/UHR among others, then the threshold should be applied to the NAV obtained from the TXOP subfield of the HE-SIG-A 2/U-SIG1 field of the PHY header. In some embodiments, the NPCA channel switch may be performed if a duration of inter-BSS activity (inter-BSS PPDU or inter-BSS TXOP) that is required to have been indicated on the primary channel of the BSS is greater than a threshold. This duration may be indicated in an NPCA minimum duration threshold field.

In some embodiments, the NPCA channel switch may be performed if the RX power of the OBSS PPDU, as received by the AP is above a certain threshold, e.g., −62 dBm. This can be indicated in a Received Signal Strength Indication (RSSI) Threshold field of FIG. 12.

In some embodiments, the AP may indicate that any STA that has enabled NPCA operation can perform the NPCA switch only if the RX power from the OBSS PPDU as observed by the STA is above a certain threshold, e.g., −62 dB m. In some embodiments, this power threshold may apply to the non-AP STAs associated with the AP but not to the AP itself. This can be indicated in a Received Signal Strength Indication (RSSI) Threshold field of FIG. 12. This can be, for example, to ensure that when the non-AP STA performs the NPCA switch, the AP also performs the switch with a high likelihood. In some embodiments, the RSSI Threshold may not be a constant for all non-AP STAs but rather it may be a function of the RSSI between the AP and the non-AP STA: RSSI_{AP-STA} or the pathloss between the AP and non-AP STA PL_{AP-STA}. In some embodiments, there may be a RSSI Threshold=A−B×RSSI_{AP-STA} or RSSI Threshold=C+D×PL_{AP-STA}, Where A, B, C, D are some constants indicated by the AP. More generally, there may be a Power Threshold=f(RSSI_{AP-STA}, PL_{AP-STA},E), where f(.) is a function predefined by the standard and E is a set of coefficients indicated by the AP. In some embodiments, it can be to ensure that NPCA is not triggered over a transmission that allows spatial reuse operation within the BSS.

In some embodiments, the NPCA switch may be performed if the OBSS transmission setting the NAV is an RTS frame and either (i) the corresponding CTS is also heard or (ii) a following data transmission is heard at the A P. This requirement can be indicated in the Response Frame Required field illustrated in FIG. 12. In this case the AP may indicate an appropriate time to start channel contention on the backup channel that is long enough to ensure that aforementioned conditions are satisfied before performing the switch to backup channel. In some embodiments, the above rules may also be applicable to other initial control frames, wherein receiving the response frame is a precondition for performing the NPCA switch.

In some embodiments, NPCA channel switch may be performed if the NAV duration overlaps with a specific window of time for which NPCA has been indicated as being enabled by the AP. The indicated information may include an indication of the start time, duration, interval, and indication validity time (persistence), among others. The time values can be with reference to the TSF time, Target Beacon Transmit Time or the frame transmission time. This information can be carried in, for example, a TWT element included within the NPCA Notification frame or NPCA Control element/field. The indication may use a TWT element to indicate these availability service periods. In some embodiments, the NPCA Notification frame or NPCA Control element/field may indicate broadcast TWT ID, and a broadcast TWT element that indicates the availability parameters may be carried in a separate field of the beacon frame. In this case, the TWT element may have a field to indicate that the TWT schedule is full or unavailable for membership.

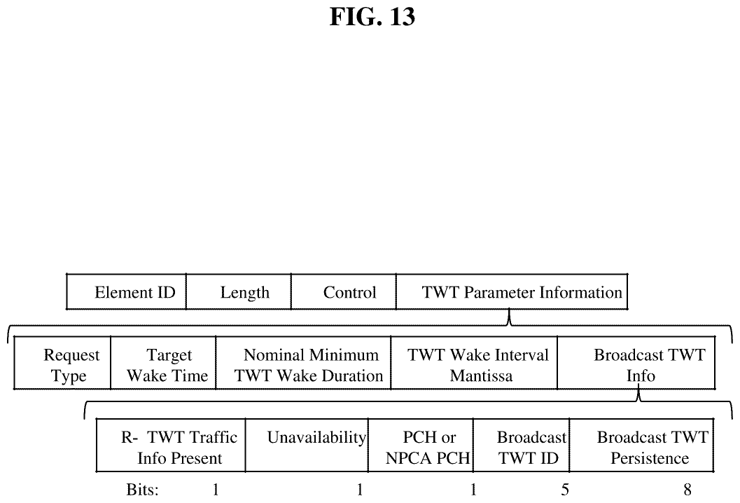

FIG. 13 illustrates a broadcast TWT element with fields to indicate that the TWT is for unavailability indication in accordance with an embodiment. The element includes an element ID field, a length field, a control field, and a TWT parameters field. The TWT parameters field includes a request type field, a target wake time field, a nominal minimum TWT wake duration field, a TWT wake interval mantissa field, and a broadcast TWT info field. The broadcast TWT info field may include a R-TWT traffic info present field, an unavailability field, a PCH or NPCA PCH field, a broadcast TWT ID field, and a broadcast TWT persistence field.

The element ID field may provide an identifier for the element. The length field may provide length information for the element. The control field may provide control information for the element. The TWT parameter information field may provide TWT parameter information. The request type field may indicate the type of TWT command, whether a station is requesting, suggesting, or demanding a TWT agreement. The target wake time field may provide target wake time information regarding scheduled specific times a device may access the network. The nominal minimum TWT wake duration field may provide information regarding a smallest amount of time a STA is expected to remain awake after being woken up by the AP for data transmission or reception. The TWT wake interval mantissa field may define an exact time interval between TWT service periods. The broadcast TWT info field may provide information broadcasting a set of schedules to multiple STAS, allowing them to wake up at pre-determined times for data transmission or reception. The R-TWT traffic info present field may indicate that the r-TWT parameter set field includes information about traffic prioritization, specifically for latency-sensitive traffic. The unavailability field may provide an indication of whether the TWT element indicates unavailability information. The PCH or NPCA PCH field may provide an indication of whether the unavailability applies to the primary channel or the NPCA primary channel. The broadcast TWT ID field may provide information that identifies a group of STAs for a shared TWT schedule, with a value of 0 indicating all TWT-enabled STAs. The broadcast TWT persistence field may indicate the number of TBTT intervals for which the TWT schedule is considered active or present.

In some embodiments, NPCA channel switch may not be performed if the NAV duration overlaps with a specific window of time for which NPCA has been indicated as being disallowed by the AP. This can be, for example, due to coexistence issues or to support multi-AP coordination such as coordinated restricted target-wake-time (RTWT) or other multi-AP negotiations with a neighboring AP. The indicated information may include an indication of the start time, duration, interval, and indication validity time (persistence), among others. The time values can be with reference to the TSF time, Target Beacon Transmit Time (TBTT) or the frame transmission time. This information can be carried in an Unavailability Windows field as illustrated in FIG. 12. The field may include, for example, a TWT element to indicate these unavailability service periods. In some embodiments, the NPCA Control element/field or NPCA Notification frame may indicate a broadcast TWT ID, and a broadcast TWT element that indicates the unavailability parameters may be carried in a separate field of the beacon frame. In this case, the broadcast TWT element may have a field to indicate that the TWT schedule is full or unavailable for membership. In some embodiments, the broadcast TWT element may have a field to indicate that the TWT is for unavailability indication as depicted in FIG. 13.

In some embodiments, NPCA channel switch avoids certain 20 MHz subchannels within the channel bonded transmission, which are indicated as being disabled for NPCA operation by the AP. These subchannels can be indicated in a NPCA Disable Subchannel Bitmap field, as illustrated in FIG. 12 in accordance with an embodiment.

In some embodiments, the AP may also indicate whether PPDUs belonging to other BSSs in the multiple BSSID set or co-hosted BSSID set as the BSS of the AP should be eligible for triggering NPCA channel switch.

In some embodiments, the AP may indicate whether or not the NPCA switch will not be triggered if spatial reuse operation is enabled by the AP, and the received PPDU allows for spatial reuse over it.

Although some of the aforementioned embodiments consider a minimum bandwidth of 20 MHz for the STA, the AP can also set the rules based on other minimum bandwidths, e.g., 80 MHz. For example, if the TXOP is initiated by a control frame in non-HT duplicate PPDU format but the bandwidth is not signaled using SERVICE bits, then such a TXOP may be used for NPCA if the TA (if present) or the RA matches a list of selected MAC addresses disclosed by the AP. These MAC addresses may correspond to other OBSS APs whose operating channel does not overlap with the AP's backup primary channel.

In some embodiments, the A P configurable rules may also indicate the subset of rules in FIGS. 10 and 11 which may be applicable or not applicable. In some embodiments, the AP may indicate the types of NPCA channel access that are permitted in the BSS: NAV duration based NPCA and/or PPDU duration based NPCA. If PPDU duration based NPCA is not allowed, then NPCA channel switch may not be triggered if PPDU is in pre-HE format and PPDU duration−PHY header duration−MAC header duration>Threshold is satisfied.

In some embodiments, some of the parameters corresponding to the different rules in FIG. 10 and FIG. 11 may also be indicated by the AP via the NPCA Control element/field, such as the thresholds: Threshold1, Threshold2 and Threshold 3 or N, the number of PHY-DATA.indication(DATA) primitives to wait.

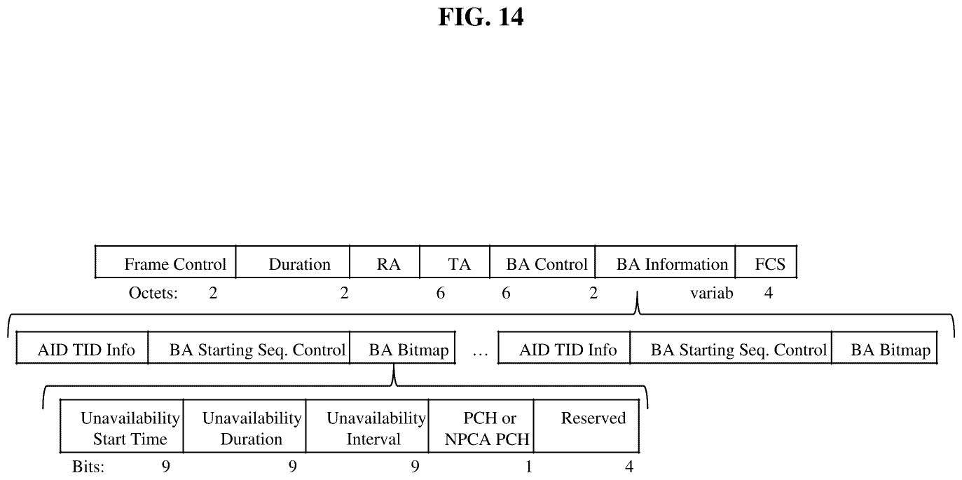

In some embodiments, some of the AP configurable rules may also be indicated by a separate frame or indication mechanism. The rules can be carried in a new frame, a new element or field in an existing frame, a new A-control field, a Multi-STA Block Ack frame, a trigger frame, or a frame sent as a trigger response, among others. In some embodiments, the indication can either be sent as a TXOP initiator or responder. In some embodiments, the unavailability indication mechanism may be common for NPCA unavailability and primary channel unavailability. There may be a field defined to indicate if the unavailability indication is applicable for NPCA backup primary channel, for primary channel (PCH) or both, as illustrated in FIG. 13 and FIG. 14 in accordance with an embodiment.

FIG. 14 illustrates an NPCA unavailability indication using a multi-STA Block Ack frame in accordance with an embodiment. The frame includes a frame control field, a duration field, a receiver address (RA) field, a transmitter address (TA) field, a BA control field, a BA information field, a frame check sequence (FCS) field. The BA information field includes an association identifier (AID) traffic identifier (TID) info field, a BA starting sequence control field, and a BA bitmap field. There can be 1 to N of these fields (AID TID info, BA starting sequence control, and BA bitmap) in the BA information field. The BA bitmap field may include an unavailability start time field, an unavailability duration field, an unavailability interval field, a PCH or NCPA PCH field, and a reserved field.

The frame control field may identify the type and subtype of the frame along with other control information. The duration field may indicate a time required for transmitting a block ack frame itself, plus one short interframe spacing (SIFS) duration. The RA field may provide receiver address information. The TA field may provide transmitter address information. The BA control field may be used to acknowledge a block of Quality of Service (QOS) data frames with a bitmap indicating which frames were successfully received. The BA information field may include information about the acknowledgement frames, including the starting sequence number and a bitmap indicating which frames were successfully received. The FCS field may be used for error detection by calculating a checksum of the frame's content. The AID TID info field may include information about acknowledgement for specific traffic streams (TIDs) associated with a particular association ID (AID). The BA starting sequence control field indicates the starting sequence number (SSN) of the data frames that the BA frame acknowledges, effectively marking the beginning of the acknowledged data stream. The BA bitmap field is a sequence of bits that indicates which frames (MPDUs) within a block of transmitted data have been successfully received by the receiver. The unavailability start time may indicate a start time that the STA may be unavailable from NPCA operation. The unavailability duration may indicate a duration during which the STA may be unavailable for NPCA operation. The unavailability interval may provide interval information regarding when the STA is unavailable periodically. The PCH or NPCA PCH provide information regarding whether the unavailability is applicable to the primary channel or the NPCA primary channel. The reserved field may be reserved.

Non-AP STA indicating configurable trigger conditions for performing NPCA channel switch in accordance with this disclosure is described herein. In some embodiments, when an A P has initiated NPCA operation, a non-AP STA may indicate to the AP if it will participate in the NPCA channel switch using the NPCA Support Notification frame as in FIG. 9 in accordance with an embodiment. The non-AP STA may not participate in NPCA, if for example, the AP's backup primary channel is outside of the operating bandwidth of the non-AP STA, non-AP STA has NSTR constraints with another link, among others.

While a non-AP STA participates in NPCA, it may also provide the AP with a list of rules based on which it will perform the channel switch. In essence, an AP can consider that a non-AP STA has performed the channel switch if both the rules indicted by the AP and the rules indicated by the non-AP STA are satisfied. Correspondingly, the AP may not schedule the non-AP STA on the backup primary channel if the rules specified by the non-AP STA are not satisfied. Some of these rules may be pre-defined in the spec, while other rules along with associated rule parameters may be indicated by the non-AP STA to the AP by transmitting a frame. This frame can be, for example, a new frame called NPCA Switch Condition Notification frame, an existing frame, or the same as the NPCA Support Notification frame used by the non-AP to enable NPCA operation. The rules at a non-AP STA for switch to backup primary channel may be based on several parameters of the Physical Protocol Data Unit (PPDU) that sets the NAV on the primary channel, including one or more of the following: the receive capability of the non-AP STA including its initial operating bandwidth, initial NSS, initial PPDU format receive capability among others, here the focus is on initial state since some STA s, such as enhanced multi-link single radio (EMLSR) STAs, can increase their receive capabilities later; the Target Wake Time schedules that have been negotiated by the non-AP STA, for example, for peer-to-peer operation; the format of the PPDU; the Transmit Address (TA) of the PPDU; the Receive Address (RA) of the PPDU; the BSS Color of the PPDU; the type of Medium Access Control (MAC) frame included within the PPDU; the PPDU bandwidth (BW); whether the PPDU BW is signaled using the SERVICE bits (if it is in a non-HT duplicate format); the NAV duration set by the PPDU; the duration of the PPDU determined from the L-SIG field; the RX power of the PPDU as seen by the non-AP STA; whether a response frame or a follow up frame to the initial PPDU has also been detected on the medium; the start and end time of the NAV set by the PPDU; whether spatial reuse over the PPDU is allowed or not, for HE+PPDUs, this is indicated for example in the Spatial Reuse field(s) in the SIG A field of the PPDU.

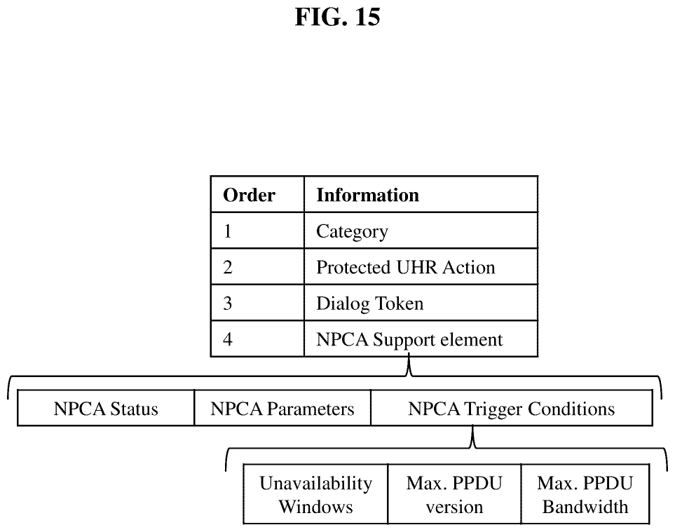

FIG. 15 illustrates NPCA Trigger Conditions indication by a non-AP STA within the NPCA Support Notification frame in accordance with an embodiment. The frame may include a category field, a protected UHR action field, a dialog token field and an NPCA support element field. The NPCA support element field may include a NPCA status field, an NPCA parameters field, and a NPCA trigger conditions field. The NPCA trigger conditions field may include an unavailability windows field, a maximum PPDU version field, and a maximum PPDU bandwidth field. Several fields illustrated in FIG. 15 may provide similar information as those already described with reference to FIG. 9 and the description of these fields has been omitted to minimize redundancy. Accordingly, in FIG. 15, the unavailability windows field may provide unavailability information during which the STA is unavailable for NPCA operation. The maximum PPDU version field may provide an indication that a NPCA channel switch may be performed if the OBSS PPDU is transmitted below a specific Physical Layer (PHY) version, e.g., in a non-HT or non-HT duplicate PPDU format. The maximum PPDU bandwidth field may indicate that the NPCA channel switch may be performed if the OBSS PPDU bandwidth is not larger than a certain threshold, such as 80 MHz. This can be, for example, to ensure that there are sufficient RUs available after switching to the backup primary channel and/or if the OBSS PPDU bandwidth does not overlap with the backup primary channel of the AP. This can be indicated in the maximum PPDU Bandwidth field.

In some embodiments, the indicated trigger conditions may be applicable upon successful transmission of the NPCA Switch Condition Notification frame or NPCA Support Notification frame. In certain embodiments, the indicated trigger conditions may be applicable after the AP sends a response NPCA Switch Condition Notification frame or a response NPCA Support Notification frame. A few examples of such rules are provided below.

In some embodiments, the NPCA channel switch may be performed by the non-AP STA if the OBSS PPDU is transmitted in a non-HT or non-HT duplicate PPDU format. This may be applicable, for example of the non-AP STA operating with limited PHY decoding capability, such as in Enhanced multi-link single radio (EM LSR) mode. In some embodiments, the NPCA channel switch may be performed by the non-AP STA if the OBSS PPDU carries a certain type of MAC frame, e.g., RTS frame, CTS frame, trigger frame, among others.

In some embodiments, the NPCA channel switch may be performed by the non-AP STA if the RA or the TA of the OBSS PPDU matches a list of MAC addresses that are disclosed by the non-AP STA to the AP. These can be the MAC addresses of a few neighboring APs that operate OBSSs in close vicinity to the non-AP STA. The list may include both transmitted and non-transmitted BSSID MAC addresses of a neighboring AP. A change in the value of the individual or group bit of the MAC address may be ignored. The list may be prepared based on the received power from the OBSS AP being above a certain threshold, or the OBSS AP's operating bandwidth not overlapping with the backup primary channel among others.

In some embodiments, the NPCA channel switch may be performed by the non-AP STA if the OBSS PPDU format is HE/EHT/UHR among others, and the BSS color indicated in the PHY header matches a list of BSS colors that is disclosed by the non-AP STA. These can be the BSS Colors of a few neighboring OBSSs in close vicinity to the non-AP STA.

In some embodiments, the NPCA channel switch may be performed by the non-AP STA if the OBSS PPDU allows identification of the PPDU bandwidth by a X MHz UHR device, where X MHz is the non-AP STAs initial operating BW. This is possible unless the format is non-HT duplicate with the SERVICE bits not indicating the bandwidth (e.g., bandwidth signaling TA is not used).

In some embodiments, the NPCA channel switch may be performed by the non-AP STA if the OBSS PPDU allows identification of the PPDU bandwidth by an X MHz device capable of receiving frames of a certain WiFi generation, e.g., non-HT.

In some embodiments, the NPCA channel switch may be performed by the non-AP STA if the OBSS PPDU allows NAV determination by an X MHz UHR device.

In some embodiments, the NPCA channel switch may be performed by the non-AP STA if the OBSS PPDU allows NAV determination by the PPDU by an X M Hz device operating capable of receiving frames of a certain WiFi generation, e.g., non-HT.

In some embodiments, the NPCA channel switch may be performed by the non-AP STA if the NAV set by the OBSS PPDU is above a certain threshold, such as 500 μs or 1 ms. If the OBSS PPDU format is before HE then the threshold should be applied to the NAV obtained from the Duration field of the MAC header. If the OBSS PPDU is HE/EHT/UHR among others, then the threshold should be applied to the NAV obtained from the TXOP subfield of the HE-SIG-A2/U-SIG1 field of the PHY header.

In some embodiments, the NPCA channel switch may be performed by the non-AP STA if the RX power of the OBSS PPDU, as received by the non-AP is above a certain threshold, e.g., −62 dBm.

In some embodiments, the NPCA switch may be performed by the non-AP STA if the OBSS transmission setting the NAV is an RTS frame and either (i) the corresponding CTS is also heard or (ii) a following data transmission is heard at the non-AP STA.

In some embodiments, NPCA channel switch may be performed by the non-AP STA if the NAV duration overlaps with a specific window of time for which NPCA has been indicated as being enabled by the non-AP STA. This information can be carried in, for example, a TWT element included within the NPCA Notification frame or NPCA Control element/field transmitted by the non-AP STA.

In some embodiments, a non-AP STA may determine to perform an NPCA switch for an OBSS transmission only if the received power from the transmission is above a threshold. This threshold can be determined by the non-AP STA by implementation. This threshold can be determined by the pathloss between the AP and the non-AP STA, any indicated received power threshold for the AP as indicated by the AP, among others.

In In some embodiments, the non-AP STA may indicate whether or not the NPCA switch will not be triggered by it if spatial reuse operation is enabled by the AP, and the received PPDU allows for spatial reuse over it. In some embodiments, a non-AP STA may also indicate periodic NPCA availability windows during which it may be available from NPCA operation.

In some embodiments, a non-AP STA may also indicate periodic NPCA unavailability windows during which it may be unavailable from NPCA operation. This can be, for example, due to power save or coexistence reasons. These unavailability windows are depicted in FIG. 15, and may include an indication of the start time, duration, interval, and indication validity time (persistence). The time values can be with reference to the TSF time or the frame transmission time. In some embodiments, a TWT element can be used for the periodic window indication. A non-AP STA may also provide instantaneous NPCA unavailability indication for a specific time window. This indication may not be periodic in nature, and can include an indication of the unavailability start time and end time, where the time values can be with reference to the TSF time or the frame transmission time.

In some embodiments, some of the non-AP configurable rules may also be indicated by a separate frame or indication mechanism. The rules can be carried in a new frame, a new element/field in an existing frame, a new A-control field, a Multi-STA Block Ack frame, or a frame sent as a trigger response, among others. Further the indication can either be sent as a TXOP initiator or responder. In some embodiments, the unavailability indication mechanism may be common for NPCA unavailability and primary channel unavailability. There may be a field defined to indicate if the unavailability indication is applicable for NPCA backup primary channel, for primary channel or both, as depicted in FIG. 14 in accordance with an embodiment.

In some embodiments, a non-AP STA may indicate if the operation on the back-up primary channel causes non-simultaneous transmit receive (NSTR) constraint at another STA affiliated with the same non-AP MLD. In some embodiments, such a non-AP STA may not be allowed to participate in NPCA operation by the AP.

In some embodiments, if an AP indicates an update to NPCA parameters, a non-AP STA's prior indication of supporting NPCA operation and the corresponding switch rules may still be applicable, till the non-AP STA sends a new indication. In some embodiments, if an AP indicates an update to NPCA parameters, implicitly all non-AP STAs may disable their participation in NPCA operation. Thus, the non-AP STAs may need to transmit a new indication of supporting NPCA operation and the corresponding switch rules.

NPCA with multi-AP coordination in accordance with this disclosure is described herein. In some embodiments, an AP may transmit an individually addressed message to a neighboring AP operating on a different primary 20 MHz channel, to request the neighboring AP to stop NPCA channel access. In the request, the AP may indicate specific time windows, and/or specific sub-bands of its operating bandwidth over which NPCA channel access should not be performed by a neighbor AP along with an appropriate Reason Code. The message may be sent, for example, in a non-HT duplicate PPDU format and it may be carried in a new Action frame called NPCA Coordination Request frame.

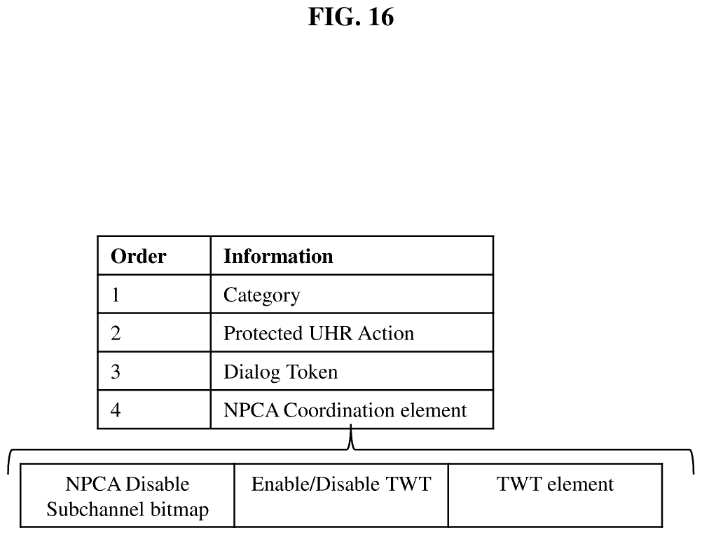

FIG. 16 illustrates an NPCA Coordination Request frame in accordance with an embodiment. The frame includes a category field, a protected UHR action field, a dialog token field and an NPCA coordination element field. Several fields illustrated in FIG. 16 may provide similar information to those already described with reference to FIG. 9 and the description of these fields has been omitted to minimize redundancy. As illustrated in FIG. 16, the NPCA Disable Subchannel Bitmap indicates the requested channels where transmission should not be performed during NPCA channel access. The enable/disable TWT field may provide an indication regarding whether TWT is requested to be enabled or disabled. The TWT element field indicates periodic service periods where NPCA operation is requested to be either enabled or disabled as indicated by the Enable/Disable TWT field. The neighboring AP may transmit a response frame indicating whether it will comply with the request. If it complies with the request, the neighboring AP may use the AP configurable trigger conditions to indicate such unavailable channels or service periods for NPCA within its BSS. In some embodiments, an AP may provide such indication via broadcast signaling in beacons. Correspondingly, any neighboring AP that decodes such beacons may comply with the request.

In some embodiments, two or more neighboring APs may exchange coordination frames to coordinate the selection of their NPCA backup primary channels such that there is a minimum frequency separation between them.

In some embodiments, when performing multi-AP coordination, the sharing AP may initiate the TXOP with an initial frame that prevents the shared AP from switching to another backup channel to perform NPCA channel access during the TXOP. In some embodiments, this indication may be implicit, by initiating the TXOP with a frame that disallows NPCA channel access by the shared A P, e.g. a CTS-to-self frame, or an RTS frame with the NAV duration set to a short value (lower than the NPCA switching threshold), or a frame with the RA set to the shared AP. In some embodiments, the indication may be explicit by initiating the TXOP with a new type of Trigger frame or a variant of an existing Trigger frame that indicates the one or more shared APs which may remain awake for the resource sharing by the sharing AP and do not perform channel switch for NPCA operation. In some embodiments, the shared AP in the response frame to the initial frame sent from the sharing AP may provide an indication to its associated STAs to prevent them from performing NPCA switch for the duration of the TXOP. In the response frame, the shared AP may also provide an indication of the duration for which NPCA operation should not be performed. In some embodiments, this indication can reuse the unavailability indication for NPCA as discussed in FIG. 14. As an example, in case of coordinated TDMA, the sharing AP may transmit a BSRP trigger frame to know about the shared AP's intent to participate, and in the response frame, which may be a QoS null frame or a Multi-STA BA frame, the shared AP may provide the indication to prevent the NPCA switch within its BSS for the duration for which the multi-AP coordination is expected to be performed.

In some embodiments, an AP that has enabled NPCA operation may not participate in some forms of multi-AP coordination. If the AP intends to participate in those multi-AP coordination mechanisms, the AP may first disable NPCA operation. As an example, such forms of multi-AP coordination may include coordinated TDMA.

In some embodiments, in certain forms of multi-AP coordination such as coordinated OFDMA, the sharing AP may win a TXOP and share part of the bandwidth with a shared AP. Since the shared bandwidth may be outside of the primary 20 MHz channel of the shared AP, NPCA access mechanism may be used by the shared AP to perform data transmission within the shared resource. In particular, the shared AP may explicitly transmit a frame to indicate the associated STAs that support NPCA to switch to the backup channel, along with an indication of the applicable backup channel. The non-AP STAs that are awake and receive the signaling may perform the switch for the duration of the TXOP. In some embodiments, the frame initiating the NPCA can be transmitted by the sharing AP instead of the shared AP.

EMLSR or DSO non-AP MLD operation with NPCA in accordance with this disclosure is described herein. In some embodiments, an EM LSR non-AP MLD or single-link EMLSR non-AP STA may not perform NPCA operation on a link on which EM LSR is enabled. In certain embodiments, an EM LSR non-AP MLD or single-link EM LSR non-AP STA may not perform NPCA operation on an EM LSR link if backup primary channel of the AP is outside of the full capability bandwidth of the non-AP STA affiliated with the non-AP MLD and operating on that link. In some embodiments, an EM LSR non-AP device may indicate that it participates in the NPCA switch if the initial frame setting the NAV on the primary channel is in the non-HT or non-HT duplicate format. In some embodiments, some additional constraints may apply, such as the frame meeting the requirements of the initial control frame for EM LSR. The AP may only trigger the EMLSR STA on the NPCA primary channel if these conditions are satisfied for the transmission on the primary channel. In some embodiments, after switching to the backup-primary channel, a single-link EM LSR device may already be capable of full bandwidth and spatial stream operation directly and an initial control frame may not be required to initiate transmission to it. In this case the AP may treat the larger of the NPCA Channel Access Delay and the EM LSR Padding Delay as the time required for non-AP MLD to be available on the NPCA primary channel after triggering the NPCA switch. In some embodiments, after switching to the backup-primary channel, an EM LSR device or a single-link EM LSR device may still operate in listen state, and therefore an EM LSR initial control frame or single-link EM LSR initial control frame may be required to initiate transmission to it after switching to the NPCA back-up primary channel. In some embodiments, similar rules may be applicable for dynamic power save operation at a non-AP STA. In some embodiments, the single link EM LSR operation may also be referred to as dynamic power save (DPS) operation.

In some embodiments, a non-AP STA operating in DSO mode may not perform NPCA operation. In certain embodiments, a DSO non-AP STA may not perform NPCA operation if backup primary channel of the AP is outside of the operating bandwidth of the non-AP STA. In some embodiments, a non-AP STA in DSO mode may indicate that it participates in the NPCA switch even if the backup primary channel is not within the initial operating bandwidth of the non-AP STA but is within the dynamic switching bandwidth of the STA. In this case the AP may treat the larger of the NPCA Channel Access Delay and the DSO Padding Delay as the time required for non-AP STA to be available on the NPCA primary channel after triggering the NPCA switch.

DPS AP operating in NPCA mode in accordance with this disclosure is described herein. In some embodiments, an AP operating in Dynamic Power Save (DPS) mode may not perform NPCA operation. In certain embodiments, an A P operating in DPS mode may not perform NPCA operation if the backup primary channel of the AP is outside of the reduced capability bandwidth of the AP. In some embodiments, an AP in DPS mode may indicate that it participates in the NPCA switch if the initial frame setting the NAV is in the non-HT or non-HT duplicate format. In some embodiments, after switching to the backup-primary channel, a DPS AP may already be in the full capability state and an initial control frame may not be required to initiate uplink transmission to it at full capabilities. In some embodiments, after switching to the backup-primary channel, the DPS AP may still be operating in the low power state on the backup-primary channel. Correspondingly, any STA intending to communicate with the AP at the high power state capabilities may need to begin the frame exchange with a DPS initial control frame.

Non-AP STA request to AP in accordance with this disclosure is described herein. In some embodiments, a non-AP STA associated with an AP may send a request to the AP to change its NPCA mode or one or more of its NPCA parameters. For example, the non-AP STA may request the AP to switch to a NPCA primary channel. This can be, for example, to ensure the non-AP STA can switch to the NPCA primary channel or the NPCA primary channel is within the non-AP STAs operating bandwidth. In some embodiments, the non-AP STA may request the AP to disable or enable NPCA operation for implementation dependent reasons. The request may be sent by the non-AP STA, for example, in an action frame that includes a Reason Code field indicating the reason for the request, some fields indicating the suggested NPCA mode or suggested N PCA parameters, and a Dialog Token field to uniquely identify each request. The AP may correspondingly transmit a response frame, either immediately or in a delayed way, to either accept or reject the request from the non-AP STA. If the request is accepted, the AP may also indicate the time when the update will be scheduled by the AP.

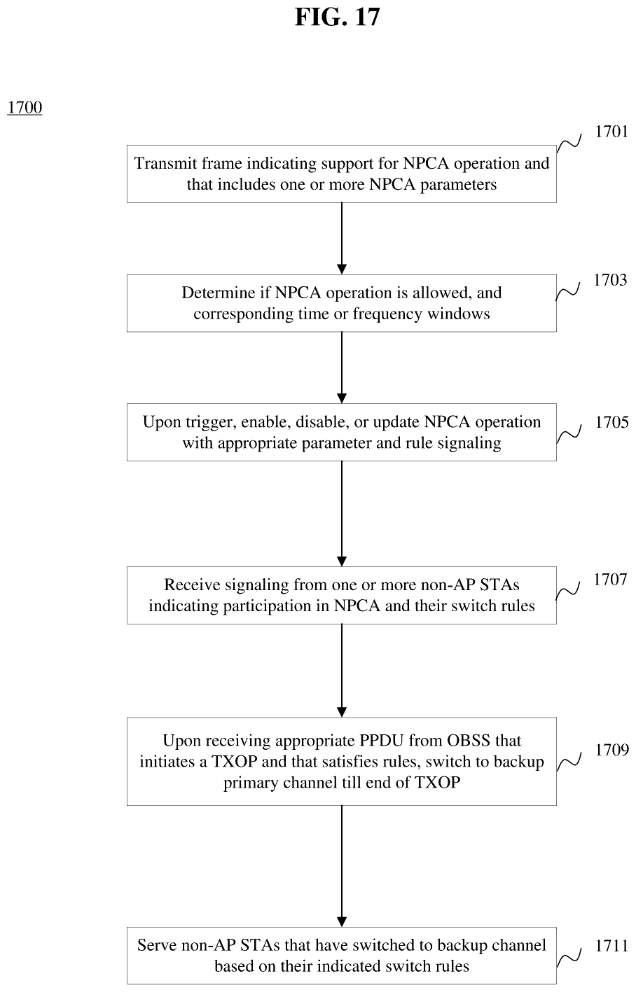

FIG. 17 illustrates a flow chart of an example process performed by an AP for initiating NPCA operation and performing channel switch to backup primary channel when appropriate in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a AP, such as the AP STA illustrated in FIG. 3.

The process 1700, in operation 1701, the AP transmits a frame indicating support for NPCA operation and includes one or more NPCA parameters. In some embodiments, the AP may indicate that it supports NPCA operation by setting a capability bit to 1 in a UHR Capabilities element that it transmits in Beacon and Probe Response frames. Otherwise, the bit may be set to 0

In operation 1703, the AP determines if NPCA operation is allowed and determines corresponding time or frequency windows. In some embodiments, the AP may also indicate the maximum NPCA Channel Access Delay, and/or maximum NPCA Transition Delay that it is willing to accommodate from any associated STA participating in NPCA operation. Correspondingly an associated non-AP STA may enable NPCA operation and participate in NPCA behavior only if the AP has enabled NPCA operation, and the non-AP STAS NPCA Channel Access Delay, and/or NPCA Transition Delay are lower than the maximum supported values indicated by the AP. In some embodiments, the maximum NPCA Channel Access Delay, and/or maximum NPCA Transition Delay can be indicated by the AP in its Ultra-High Reliability (UHR) Capabilities element in the Maximum NPCA Channel Access Delay, and Maximum NPCA Transition Delay fields, respectively. In some embodiments, these values can be indicated in another element, such as the UHR Operation element, or frame transmitted by the AP. In some embodiments, these values can be indicated by the AP during the NPCA enablement procedure as described herein. In some embodiments, after determining that an observed transmission on the primary channel is eligible for performing NPCA switch, the AP shall initiate the channel access and/or the transmissions on the NPCA backup primary channel the Maximum MPCA Channel Access Delay after that determination time.

In operation 1705, the AP, upon trigger, enables, disables or updates NPCA operation with appropriate parameters and rule signaling. In some embodiments, an AP that indicates support for NPCA implicitly has NPCA operation enabled. In some embodiments, NPCA operation may be a mode that can be enabled or disabled by the AP for its BSS by performing broadcast signaling.

In operation 1707, the A P receives signaling from one or more non-AP STAs indicating participation in NPCA and the non-AP STAs NPCA switching rules. In some embodiments, the non-AP STA may transmit a frame to the AP, which may be referred to as a NPCA Support Notification frame, to enable or disable its participation in NPCA operation. In some embodiments, the non-AP STA may also transmit this frame to indicate any change of its NPCA parameters or NPCA channel switch triggering conditions. This frame may include an indication of one or more of the following. The purpose of signaling, including enable, disable or Update of NPCA operation, carried in, for example, an NPCA Status field. An indication of one or more NPCA parameters that are applicable to the non-AP STA. A list of STA-specific trigger conditions for NPCA channel switch, along with applicable parameters.

In operation 1709, the AP, upon receiving an appropriate PPDU from the OBSS that initiates a TXOP and that satisfies one or more rules, switches to a backup primary channel until the end of the TXOP.

In operation 1711, the AP serves non-AP STAs that have switched to the backup primary channel based on their indicated switch rules.

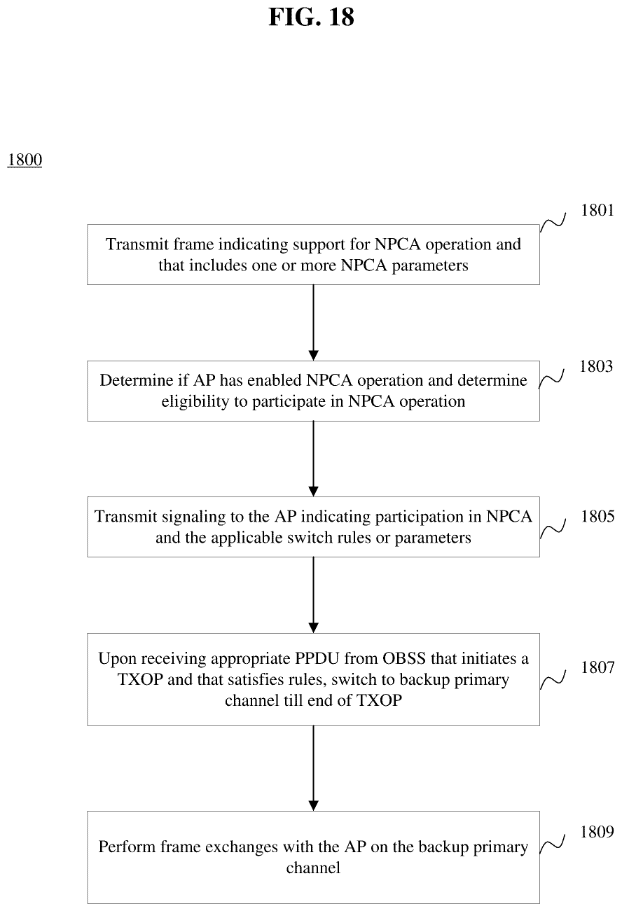

FIG. 18 illustrates a flow chart of an example process performed by a non-AP STA for supporting NPCA operation and performing channel switch to backup primary channel when appropriate in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a non-AP STA, such as the non-AP STA illustrated in FIG. 3.

The process 1800, in operation 1801, the STA transmits a frame indicating support for NPCA operation and that includes one or more NPCA parameters. In some embodiments, the non-AP STA may transmit a frame to indicate any change of its NPCA parameters or NPCA channel switch triggering conditions. This frame may include an indication of one or more of the following. The purpose of signaling, including enable, disable or Update of NPCA operation, carried in, for example, an NPCA Status field. An indication of one or more NPCA parameters that are applicable to the non-AP STA. A list of STA-specific trigger conditions for NPCA channel switch, along with applicable parameters.

In operation 1803, the STA determines if the AP has enabled NPCA operation and determines eligibility to participate in NPCA operation.

In operation 1805, the STA transmits signaling to the AP indicating participation in NPCA and the applicable switch rules or parameters. In some embodiments, when an AP has initiated NPCA operation, a non-AP STA may indicate to the AP if it will participate in the NPCA channel switch using the NPCA Support Notification frame as in FIG. 9 in accordance with an embodiment. The non-AP STA may not participate in NPCA, if for example, the AP's backup primary channel is outside of the operating bandwidth of the non-AP STA, non-AP STA has NSTR constraints with another link, among others. While a non-AP STA participates in NPCA, it may also provide the AP with a list of rules based on which it will perform the channel switch. In essence, an AP can consider that a non-AP STA has performed the channel switch if both the rules indicated by the AP and the rules indicated by the non-AP STA are satisfied.

In operation 1807, the STA, upon receiving appropriate PPDU from OBSS that initiates a TXOP and that satisfies rules, switches to backup primary channel till end of TXOP.

In operation 1809, the STA performs frame exchanges with the AP on the backup primary channel.

Embodiments in accordance with this disclosure provide procedures for an AP and non-AP STA to enable and manage NPCA operation, and appropriate rules for triggering channel switch to a backup primary channel during NPCA operation which allow decreasing channel access latency and improving spectrum utilization. NPCA switch rules may be utilized whereby the STA and AP may coordinate transitioning to the backup primary channel without causing disruption to a neighboring AP operating on the channel, which may minimize power utilization and avoid hidden node issues where some STAs may transition to the backup primary channel when the AP does not and vice versa, which would otherwise waste power.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, the AP comprising:
a memory; and
a processor coupled to the memory, the processor configured to:
operate on a primary channel within a basic service set (BSS) bandwidth;
transmit, to a station (STA), a first frame including a first field indicating whether NPCA operation is enabled;
in a case that the first field indicates the NPCA operation is enabled, switch from the primary channel to an NPCA primary channel within the BSS bandwidth based on a determination that i) a physical-layer protocol data unit (PPDU) observed on the primary channel is classified as an inter-BSS PPDU, and ii) an operating channel occupied by the PPDU does not overlap with the NPCA primary channel; and
transmit, to the STA, a second frame on the NPCA primary channel.

2. The AP of claim 1, wherein the processor is configured to:
transmit, to the STA, a third frame indicating whether the AP supports NPCA operation.

3. The AP of claim 1, wherein the processor is configured to:
switch from the primary channel to the NPCA primary channel based on a determination that a duration of the PPDU is greater than a predetermined value.

4. The AP of claim 1, wherein the processor is configured to:
switch from the primary channel to the NPCA primary channel based on a duration of a transmission opportunity (TXOP) associated with the PPDU is greater than a predetermined value.

5. The AP of claim 1, wherein the first frame includes:
a second field indicating a time needed to switch from the primary channel to the NPCA primary channel; and
a third field indicating a time needed to switch back from the NPCA primary channel to the primary channel.

6. The AP of claim 1, wherein the first frame includes a second field that indicates a channel number of a channel within the BSS bandwidth that corresponds to the NPCA primary channel.

7. The AP of claim 1, wherein the first frame includes a second field that indicates a minimum duration of the PPDU or the TXOP on the primary channel to switch to the NPCA primary channel.

8. The AP of claim 7, wherein the processor is configured to:
determine that the duration of the PPDU is greater than a value indicated in the minimum duration of the second field.

9. The AP of claim 7, wherein the processor is configured to:
determine that the duration of the TXOP is greater than a value indicated in the minimum duration of the second field.

10. The AP of claim 1, wherein the processor is configured to:
in a case that the first field indicates that the NPCA operation is not enabled, abstain from switching from the primary channel to the NPCA primary channel.

11. A station (STA) in a wireless network, the STA comprising:
a memory; and
a processor coupled to the memory, the processor configured to:
operate on a primary channel within a basic service set (BSS) bandwidth;
receive, from an access point (AP), a first frame including a first field indicating whether NPCA operation is enabled;
in a case that the first field indicates the NPCA operation is enabled, the STA may enable NPCA operation and switch from the primary channel to an NPCA primary channel within the BSS bandwidth based on a determination that i) a physical-layer protocol data unit (PPDU) observed on the primary channel is classified as an inter-BSS PPDU and ii) an operating channel occupied by the PPDU does not overlap with the NPCA primary channel; and
receive, from the AP, a second frame on the NPCA primary channel.

12. The STA of claim 11, wherein the processor is configured to transmit a third frame to the AP indicating whether the STA supports NPCA operation.

13. The STA of claim 11, wherein the processor is configured to:
receive, from the AP, a third frame indicating whether the AP supports NPCA operation.

14. The STA of claim 11, wherein the processor is configured to:
switch from the primary channel to the NPCA primary channel based on a determination that a duration of the PPDU is greater than a predetermined value.

15. The STA of claim 11, wherein the processor is configured to:
switch from the primary channel to the NPCA primary channel based on a duration of a transmission opportunity (TXOP) associated with the PPDU is greater than a predetermined value.

16. The STA of claim 11, wherein the first frame includes:
a second field indicating a time needed to switch from the primary channel to the NPCA primary channel; and
a third field indicating a time needed to switch back from the NPCA primary channel to the primary channel.

17. The STA of claim 11, wherein the first frame includes a second field that indicates a channel number of a channel within the BSS bandwidth that corresponds to the NPCA primary channel.

18. The STA of claim 11, wherein the first frame includes a second field that indicates a minimum duration of the PPDU or the TXOP on the primary channel to switch to the NPCA primary channel.

19. The STA of claim 18, wherein the processor is configured to:
determine that the duration of the PPDU is greater than a value indicated in the minimum duration of the second field.

20. The STA of claim 18, wherein the processor is configured to:
determine that the duration of the TXOP is greater than a value indicated in the minimum duration of the second field.
